(19) United States
(12) Patent Application Publication
(10) Pub. No.: US 2026/0281969 A1
(43) Pub. Date: Sep. 17, 2026

(54) Initiating Positioning or Sensing Measurements by an Assisting User Equipment (UE)

(71) Applicant: Telefonaktiebolaget LM Ericsson (publ), Stockholm (SE)

(72) Inventors: Ritesh Shreevastav, Upplands Väsby (SE); Thomas Johansson, Åby (SE); Göran Rune, Linköping (SE); Richárd Bátorfi, Budapest (HU); Gino Luca Masini, Stockholm (SE); Yazid Lyazidi, London (GB)

(21) Appl. No.: 19/166,930

(22) PCT Filed: Mar. 28, 2024
(86) PCT No.: PCT/SE2024/050292

§ 371 Date: Sep. 19, 2025

Related U.S. Application Data
(60) Provisional application No. 63/455,604, filed on Mar. 30, 2023.

(51) Int. Cl. H04W 64/00; G01S 5/02; H04W 4/029; H04W 76/20

(52) U.S. Cl. CPC H04W 64/006; G01S 5/0236; H04W 4/029; H04W 76/20

(57) ABSTRACT

Embodiments include methods for a user equipment (UE) configured to assist with positioning and/or sensing operations in a communication network. Such methods include receiving, from a radio access network (RAN) node, a first indication that assisting UEs are needed for positioning or sensing operations related to a target other than the UE. Such methods include, in response to the first indication, sending one or more of the following information to a network function (NF) configured to manage positioning and/or sensing operations in the communication network: a second indication that the UE is available to assist with the positioning or sensing operations related to the target, the UE's location, and one or more measurements related to the target. Other embodiments include complementary methods for a RAN node and for an NF, as well as UEs, RAN nodes, and NFs configured to perform such methods.

### TECHNICAL FIELD

The present disclosure relates generally to positioning or sensing operations performed in a radio access network (RAN), and more specifically to techniques for initiating (or triggering) measurements by user equipment (UEs) configured to assist with positioning or sensing with respect to targets such as other UEs or objects that cannot connect to the RAN.

### BACKGROUND

Currently the fifth generation (5G) of cellular systems is being standardized within the Third-Generation Partnership Project (3GPP). 5G is developed for maximum flexibility to support many different use cases including enhanced mobile broadband (eMBB), machine type communications (MTC), ultra-reliable low latency communications (URLLC), side-link device-to-device (D2D), and several other use cases.

FIG. 1 illustrates a high-level view of an exemplary 5G network architecture, consisting of a Next Generation Radio Access Network (NG-RAN, 199) and a 5G Core (5GC, 198). The NG-RAN can include one or more gNodeB's (gNBs) connected to the 5GC via one or more NG interfaces, such as gNBs (100, 150) connected via respective interfaces (102, 152). More specifically, the gNBs can be connected to one or more Access and Mobility Management Functions (AMFs) in the 5GC via respective NG-C interfaces and to one or more User Plane Functions (UPFs) in 5GC via respective NG-U interfaces. The 5GC can include various other network functions (NFs), such as Session Management Function(s) (SMF).

NG RAN logical nodes (e.g., gNB 100) include a Central Unit (CU or gNB-CU, e.g., 110) and one or more Distributed Units (DU or gNB-DU, e.g., 120, 130). CUs are logical nodes that host higher-layer protocols and perform various gNB functions such controlling the operation of DUs. DUs are decentralized logical nodes that host lower layer protocols and can include, depending on the functional split option, various subsets of the gNB functions. Each CU and DU can include various circuitry needed to perform their respective functions, including processing circuitry, communication interface circuitry (e.g., transceivers), and power supply circuitry.

A gNB-CU connects to one or more gNB-DUs over respective F1 logical interfaces (e.g., 122 and 132 shown in FIG. 1). However, each gNB-DU can be connected to only one gNB-CU. The gNB-CU and its connected gNB-DU(s) are only visible to other gNBs and the 5GC as a gNB. In other words, the F1 interface is not visible beyond gNB-CU.

Another change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services.

3GPP standards provide various ways for positioning (e.g., determining the position of, locating, and/or determining the location of) UEs operating in 3GPP networks. In general, a positioning node configures the target device (e.g., UE) and/or a RAN node to perform one or more positioning measurements according to one or more positioning methods. For example, the positioning measurements can include timing (and/or timing difference) measurements on UE, network, and/or satellite transmissions. The positioning measurements are used by the target device, the RAN node, and/or the positioning node to determine the location of the target device.

NR Rel-16 positioning was developed based on network-transmitted positioning reference signals (PRS), which can provide added value in terms of enhanced location capabilities. For example, PRS transmission in low and high frequency bands (e.g., below and above 6 GHz) and use of massive antenna arrays provide additional degrees of freedom to substantially improve positioning accuracy.

One positioning enhancement being discussed for 3GPP Rel-17 and beyond is the use of positioning reference units (PRUs) in the network. A PRU is a network node or device, at a known location, which can transmit uplink (UL) reference signals, perform positioning measurements, and report these measurements to a positioning node. In this manner, PRUs can help identify positioning errors and facilitate compensation for these errors in positions determined for UEs that are proximate in the network. From the positioning node's perspective, the PRU is considered to be a UE at a known location.

Recently, 3GPP defined some use cases and requirements for sensing in 3GPP TR 22.837 (v0.3.0) and has defined study items to identify use cases and architectural enhancements that will enable joint communications and sensing (JCAS) in cellular networks. JCAS is also known as Integrated Sensing and Communication (ISAC). In this context, the general goal of sensing is to detect and localize a target that is not necessarily connected to the network, such as a pedestrian, an animal, an object, etc.

Sensing involves the network transmitting radio signals and receiving/measuring versions of those signals that have been reflected by the target (and possibly other surroundings). The transmitting and receiving can be performed by the same node(s) or by different node(s). Processing output of the sensing measurements yields information of the target and its surroundings that the radio signals interacted with, possibly including sources of attenuation, reflection, refraction, etc.

A sensing request may originate from applications external to the network. 3GPP has defined a Sensing Management Function (SeMF) to handle these requests and to trigger the necessary sensing operations in the RAN, including any UEs that have capability to assist with the sensing. SeMF is a logical entity that resides in the RAN (e.g., gNB) or in 5GC (e.g., a NF).

### SUMMARY

An unresolved technical issue is how PRUs should be registered in a 5G network, such that other network nodes or functions are aware of their existence and capabilities. Different proposed solutions involve storing PRU information (including location) in the NRF in 5GC. However, this violates some general policies for use of NRF.

For example, NRF is generally expected to handle static storage and is not designed to handle frequently updated information. Even if a PRU's location is known, it may also change as the PRU (as a UE) moves around the network. This may occur frequently since there are no restrictions on PRU movement. In such case, the PRU's information stored in NRF would need to be updated frequently, which violates policies on NRF usage. Similar problems may occur when information of UEs that assist with sensing is stored in NRF, since locations of the sensing UEs may also change frequently.

An object of embodiments of the present disclosure is to improve network management of information about UEs that assist with measurement or sensing tasks in the network, such as by providing, enabling, and/or facilitating solutions to overcome exemplary problems summarized above and described in more detail below.

Embodiments include methods (e.g., procedures) for a UE configured to assist with positioning and/or sensing operations in a communication network. These exemplary methods include receiving from a RAN node a first indication that assisting UEs are needed for positioning or sensing operations related to a target other than the UE. These exemplary methods also include, in response to the first indication, sending one or more of the following information to an NF configured to manage positioning and/or sensing operations in the communication network: a second indication that the UE is available to assist with the positioning or sensing operations related to the target, the UE's location, and one or more measurements related to the target.

In some embodiments, the first indication is received in a system information block (SIB) broadcast by the RAN node in a cell in which the UE is located. In other embodiments, the first indication is received as a reference signal (RS) transmitted by the RAN node. In some embodiments, the first indication is received while the UE is in a non-connected state with respect to the RAN, and these exemplary methods also include, where in response to the first indication, entering a connected state with respect to the RAN, after which the information is sent to the NF.

In some embodiments, the first indication is received together with one or more of the following: an address or identifier associated with the NF, one or more measurement reporting conditions for assisting UEs, and configuration of requested measurements. In some of these embodiments, the measurement reporting conditions include one or more of the following: area of interest, minimum downlink (DL) signal strength, minimum DL signal quality, and line-of-sight (LOS) from assisting UE to RAN node.

In some of these embodiments, the configuration of requested measurements includes one or more of the following: measurement type, one or more identifiers associated with RS to be measured, measurement duration, need for measurement uncertainty, need for UE location, and need for periodic measurement reporting. In some variants of these embodiments, the one or more identifiers associated with RS to be measured include one or more of the following: index of a synchronization signal/PBCH (SSB) to be measured, identifier of a transmission/reception point (TRP) that transmits a RS to be measured, identifier of a positioning reference signal (PRS) resource set to be measured, and identifier of a PRS resource to be measured.

In some of these embodiments, the information sent to the NNF is based on one or more of the following: determining that the one or more measurement reporting conditions have been met, and the configuration of requested measurements.

In some embodiments, the second indication and the one or more measurements are sent in a single message. In other embodiments, the second indication is sent in a first message and the one or more measurements are sent in a subsequent second message.

In some embodiments, the UE is a PRU and the NF is an LMF in a 5GC. In other embodiments, the UE is a sensing UE and the NF is an SeMF in a 5GC.

Other embodiments include methods (e.g., procedures) for an NF configured to manage positioning and/or sensing operations in a communication network. These exemplary methods include transmitting, to a RAN node, a first indication that assisting UEs are needed for positioning or sensing operations related to a target. These exemplary methods also include subsequently receiving) one or more of the following information from each of one or more UEs, other than the target: a second indication that the UE is available to assist with the positioning or sensing operations related to the target, the UE's location, and one or more measurements related to the target.

In some embodiments, the first indication is sent in a request to broadcast the indication in one or more cells served by the RAN node. In other embodiments, the first indication is sent in a request for the RAN node to transmit a RS associated with the requested positioning or sensing operations. In some embodiments, the first indication is sent to the RAN node using a point-to-point protocol between the NF and the RAN node. In other embodiments, the first indication is sent to a core network node for forwarding to the RAN node.

In some embodiments, the first indication is sent together with one or more of the following: an address or identifier associated with the NF, one or more measurement reporting conditions for assisting UEs, and configuration of requested measurements. In some of these embodiments, the measurement reporting conditions include one or more of the following: area of interest, minimum DL signal strength, minimum DL signal quality, and LOS from assisting UE to RAN node.

In some of these embodiments, the configuration of requested measurements includes one or more of the following: measurement type, one or more identifiers associated with RS to be measured, measurement duration, need for measurement uncertainty, need for UE location, and need for periodic measurement reporting. In some variants of these embodiments, the one or more identifiers associated with RS to be measured include one or more of the following: index of an SSB to be measured, identifier of a TRP that transmits a RS to be measured, identifier of a PRS resource set to be measured, and identifier of a PRS resource to be measured.

In some of these embodiments, the information received from each of the one or more UEs is based on one or more of the following: the UE determining that the measurement reporting conditions are met, and the configuration of requested measurements.

In some embodiments, the second indication and the one or more measurements are received in a single message. In other embodiments, the second indication is received in a first message and the one or more measurements are received in a subsequent second message.

In some embodiments, these exemplary methods also include performing the positioning or sensing operations related to the target based on the one or more measurements received from each of the one or more UEs. In some embodiments, transmitting the second indication to the RAN node is based on determining that no stationary assisting UEs are available in an area proximate to the target.

In some embodiments, the UE is a PRU and the NF is an LMF in a 5GC. In other embodiments, the UE is a sensing UE and the NF is an SeMF in a 5GC.

Other embodiments include methods (e.g., procedures) for a RAN node configured to facilitate positioning and/or sensing operations in a communication network. These exemplary methods include receiving, from an NF configured to manage positioning and/or sensing operations in the communication network, a first indication that assisting UEs are needed for positioning or sensing operations related to a target. These exemplary methods also include in transmitting, in one or more cells served by the RAN node, a further first indication that assisting UEs are needed by the NF for the positioning or sensing operations related to the target.

In some embodiments, the first indication is received as a request to broadcast the indication in one or more cells served by the RAN, and the further first indication is transmitted in a SIB broadcast by the RAN node in the one or more cells. In other embodiments, the first indication is received in a request for the RAN node to transmit a RS associated with the positioning or sensing operations related to the target, and the further first indication is transmitted as the RS associated with the positioning or sensing operations. In some embodiments, the first indication is received from the NF using a point-to-point protocol between the NF and the RAN node. In other embodiments, the first indication is received via a core network node coupled to the RAN node.

In some embodiments, the first indication is received, and the further first indication is transmitted, together with one or more of the following: an address or identifier associated with the NF, one or more measurement reporting conditions for assisting UEs, and a configuration of requested measurements. In some of these embodiments, the measurement reporting conditions include one or more of the following: area of interest, minimum DL signal strength, minimum DL signal quality, and LOS from assisting UE to RAN node.

In some of these embodiments, the configuration of requested measurements includes one or more of the following: measurement type, one or more identifiers associated with RS to be measured, measurement duration, need for measurement uncertainty, need for UE location, and need for periodic measurement reporting. In some variants of these embodiments, one or more identifiers associated with RS to be measured include one or more of the following: index of an SSB to be measured, identifier of a TRP that transmits a PRS to be measured, identifier of a PRS resource set to be measured, and identifier of a PRS resource to be measured.

In some embodiments, the RAN node comprises a centralized unit (CU) and one or more distributed units (DUs). In such embodiments, receiving the first indication is performed by the CU and transmitting the further first indication in the one or more cells is performed by the one or more DUs. Also, these exemplary methods also include the CU forwarding the first indication to the one or more DUs.

In some embodiments, the UE is a PRU and the NF is an LMF in a 5GC. In other embodiments, the UE is a sensing UE and the NF is an SeMF in a 5GC.

Other embodiments include UEs (e.g., wireless devices, NSPS devices, etc.), NFs (e.g., LMFs, SeMFs), and RAN nodes (e.g., base stations, eNBs, gNBs, en-gNBs, etc.) configured to perform operations corresponding to any of the exemplary methods described herein. Other embodiments include non-transitory, computer-readable media storing program instructions that, when executed by processing circuitry, configure such UEs, NFs, and RAN nodes to perform operations corresponding to any of the exemplary methods described herein.

These and other embodiments described herein may enable LMF/SeMF to identify available assisting UEs without maintaining a database (e.g., in NRF) that needs to be frequently updated as UEs move. Moreover, embodiments may enable more timely identification of available UEs than other solutions that require LMF-to-LMF interactions. Each LMF can efficiently identify available UEs in its served area. Moreover, embodiments may facilitate deployment of assisting UEs that can identify themselves as sensing UEs and/or PRUs, but can utilize thresholds, etc. to avoid the LMF/SeMF receiving too many offers from such assisting UEs.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 illustrates a high-level view of an exemplary 5G/NR network architecture.

FIG. 2 illustrates a high-level architecture for UE positioning in NR networks.

FIG. 3 shows signaling diagrams for four different solutions for positioning reference unit (PRU) management.

FIG. 4 illustrates three different sensing techniques that can be used in a cellular network.

FIG. 5 illustrates how a sensing management function (SeMF) can control sensing patterns for three gNBs.

FIGS. 6-7 are signal flow diagrams according to various embodiments of the present disclosure.

FIG. 8 shows an ASN.1 data structure according to various embodiments of the present disclosure.

FIG. 9 shows a flow diagram of an exemplary method (e.g., procedure) for a UE (e.g., wireless device), according to various embodiments of the present disclosure.

FIG. 10 shows a flow diagram of an exemplary method (e.g., procedure) for a network function (NF, e.g., LMF, SeMF), according to various embodiments of the present disclosure.

FIG. 11 shows a flow diagram of an exemplary method (e.g., procedure) for a RAN node (e.g., base station), according to various embodiments of the present disclosure.

FIG. 12 shows a communication system according to various embodiments of the present disclosure.

FIG. 13 shows a UE according to various embodiments of the present disclosure.

FIG. 14 shows a network node according to various embodiments of the present disclosure.

FIG. 15 shows a host computing system according to various embodiments of the present disclosure.

FIG. 16 is a block diagram of a virtualization environment in which functions implemented by some embodiments of the present disclosure may be virtualized.

FIG. 17 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided as examples to convey the scope of the subject matter to those skilled in the art.

In general, all terms used herein are to be interpreted according to their ordinary meaning to a person of ordinary skill in the relevant technical field, unless a different meaning is expressly defined and/or implied from the context of use. All references to a/an/the element, apparatus, component, means, step, etc. are to be interpreted openly as referring to at least one instance of the element, apparatus, component, means, step, etc., unless explicitly stated otherwise or clearly implied from the context of use. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node, IAB node) based on its specific characteristics in any given context.
Base station: As used herein, a “base station” may comprise a physical or a logical node transmitting or controlling the transmission of radio signals, e.g., eNB, gNB, ng-eNB, en-gNB, centralized unit (CU)/distributed unit (DU), transmitting radio network node, transmission point (TP), transmission reception point (TRP), remote radio head (RRH), remote radio unit (RRU), Distributed Antenna System (DAS), relay, etc.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system and can be applied to any communication system that may benefit from them.

As briefly mentioned above, 3GPP standards provide various ways for positioning (e.g., determining the position of, locating, and/or determining the location of) UEs operating in 3GPP networks. The following positioning methods are supported in NR:
Enhanced Cell ID (E-CID). Utilizes information to associate the UE with the geographical area of a serving cell, and then additional information to determine a finer granularity position. The following measurements are supported for E-CID: AoA (base station only), UE Rx-Tx time difference, timing advance (TA) types 1 and 2, reference signal received power (RSRP), and reference signal received quality (RSRQ).
Assisted GNSS. The UE receives and measures signals transmitted by GNSS satellites (e.g., GPS), supported by assistance information provided to the UE by a positioning node.
OTDOA (Observed Time Difference of Arrival). The UE receives and measures DL RS (e.g., PRS) transmitted by the RAN, supported by assistance information provided to the UE by a positioning node.
UTDOA (Uplink TDOA). The UE transmits UL RS (e.g., SRS) that are detected and measured by RAN nodes at known positions. These measurements are forwarded to a positioning node for multilateration.
Multi-RTT: Both UE and RAN nodes compute Rx-Tx time differences, with the results being combined by a positioning node to find the UE position based upon round trip time (RTT) calculation.
DL angle of departure (DL-AoD): RAN node or positioning node calculates the UE angular position based upon UE DL RSRP measurement results (e.g., of PRS transmitted by RAN nodes).
UL angle of arrival (UL-AoA): RAN node calculates the UL AoA based upon measurements of a UE's UL SRS transmissions.

In addition to these methods, a UE can also perform positioning measurements (and optionally calculate position) based on WLAN signals, Bluetooth signals, terrestrial beacon system (TBS) signals, and UE sensors (e.g., barometric pressure, accelerometer, etc.).

Additionally, one or more of the following positioning modes can be utilized in each of the positioning methods listed above:
UE-Assisted: The UE performs measurements with or without assistance from the network and sends these measurements to the E-SMLC where the position calculation may take place.
UE-Based: The UE performs measurements and calculates its own position with assistance from the network.
Standalone: The UE performs measurements and calculates its own position without network assistance.

The detailed assistance data may include information about network node locations, beam directions, etc. The assistance data can be provided to the UE via unicast or via broadcast.

FIG. 2 is a block diagram illustrating a high-level architecture for supporting UE positioning in NR networks. NG-RAN (220) can include nodes such as gNBs (e.g., 222) and ng-eNBs (e.g., 221). Each ng-eNB provides the fourth generation (4G) LTE radio interface and may control several transmission points (TPs), such as remote radio heads. Similarly, each gNB may control several transmission/reception points (TRPs).

In addition, the NG-RAN nodes communicate with an Access and Mobility Management Function (AMF, 230) in the 5GC via respective NG-C interfaces (both of which may or may not be present), while the AMF communicates with a location management function (LMF, 240) via an NLs interface (241). The LMF supports various functions related to UE positioning, including location determination for a UE, obtaining DL location measurements or a location estimate from the UE, obtaining UL location measurements from the NG RAN, and obtaining non-UE associated assistance data from the NG RAN.

In addition, positioning-related communication between UEs (e.g., 210) and NG-RAN nodes occurs via the RRC protocol, while positioning-related communication between NG-RAN nodes and LMF occurs via an NRPPa protocol. Optionally, the LMF can also communicate with an enhanced serving mobile location center (E-SMLC, 250) and a secure user plane location platform (SLP, 260) in an LTE network via communication interfaces 251 and 261, respectively. These communication interfaces can be implemented according to standardized protocols, proprietary protocols, or a combination thereof.

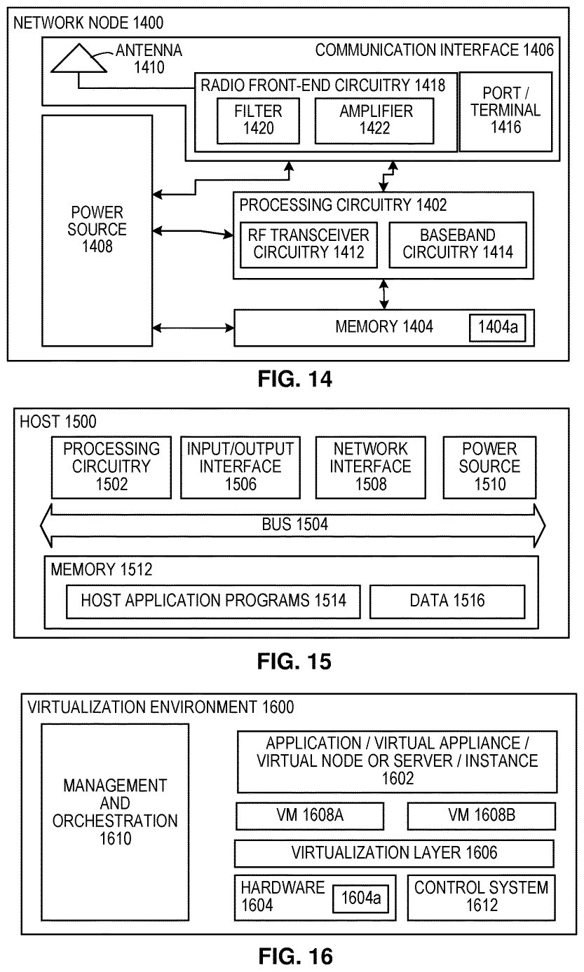

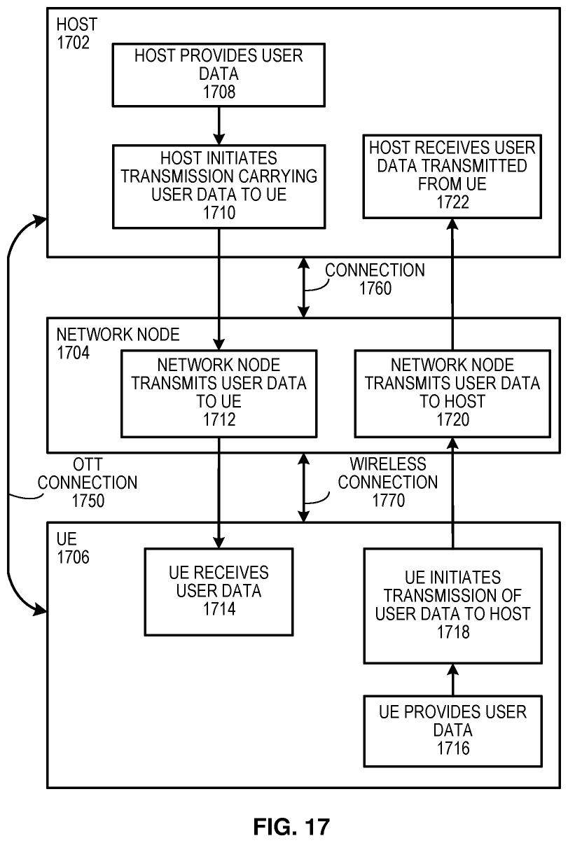

The LMF can also include, or be associated with, various processing circuitry (242), by which the LMF performs various operations described herein. The processing circuitry can include similar types of processing circuitry as described herein in relation to other network nodes (see, e.g., description of FIGS. 14 and 16). The LMF can also include, or be associated with, a non-transitory computer-readable medium (243) storing instructions (also referred to as a computer program product) that can facilitate the operations of the processing circuitry. The medium can include similar types of computer memory as described herein in relation to other network nodes (see, e.g., description of FIGS. 14 and 16). Additionally, the LMF can include various communication interface circuitry (241, e.g., Ethernet, optical, and/or radio transceivers) that can be used, e.g., for communication via the NLs interface. For example, the communication interface circuitry can be similar to other interface circuitry described herein in relation to other network nodes (see, e.g., description of FIGS. 14 and 16).

Similarly, the E-SMLC can include, or be associated with, various processing circuitry (252), by which the E-SMLC performs various operations described herein. The processing circuitry can include similar types of processing circuitry as described herein in relation to other network nodes (see, e.g., description of FIGS. 14 and 16). The E-SMLC can also include, or be associated with, a non-transitory computer-readable medium (253) storing instructions (also referred to as a computer program product) that can facilitate the operations of the processing circuitry. The medium can include similar types of computer memory as described herein in relation to other network nodes (see, e.g., description of FIGS. 14 and 16). The E-SMLC can also have communication interface circuitry that is appropriate for communicating via an interface (251), which can be similar to other interface circuitry described herein in relation to other network nodes (see, e.g., description of FIGS. 14 and 16).

Similarly, the SLP can include, or be associated with, various processing circuitry (262), by which the SLP performs various operations described herein. The processing circuitry can include similar types of processing circuitry as described herein in relation to other network nodes (see, e.g., description of FIGS. 14 and 16). The SLP can also include, or be associated with, a non-transitory computer-readable medium (263) storing instructions (also referred to as a computer program product) that can facilitate the operations of the processing circuitry. The medium can include similar types of computer memory as described herein in relation to other network nodes (see, e.g., description of FIGS. 14 and 16). The SLP can also have communication interface circuitry that is appropriate for communicating via an interface (261), which can be similar to other interface circuitry described herein in relation to other network nodes (see, e.g., description of FIGS. 14 and 16).

In a typical operation, the AMF can receive a request for a location service associated with a particular target UE from another entity (e.g., a gateway mobile location center, GMLC), or the AMF can initiate a location service on behalf of a particular target UE (e.g., for an emergency call by the UE). The AMF then sends a location services (LS) request to the LMF. The LMF processes the LS request, which may include transferring assistance data to the target UE to assist with UE-based and/or UE-assisted positioning; and/or positioning of the target UE. The LMF then returns the result of the LS (e.g., a position estimate for the UE and/or an indication of any assistance data transferred to the UE) to the AMF or to another entity (e.g., GMLC) that requested the LS.

An LMF may have a signaling connection to an E-SMLC, enabling the LMF to access information from E-UTRAN, e.g., to support E-UTRA OTDOA positioning by obtaining measurements made by a target UE based on DL PRS. An LMF can also have a signaling connection to an SLP, the LTE entity responsible for user-plane positioning.

Various interfaces and protocols are used for, or involved in, NR positioning. The LTE Positioning Protocol (LPP) is used between a target device (e.g., UE in the control-plane, or SET in the user-plane) and a positioning server (e.g., LMF in the control-plane, SLP in the user-plane). LPP can use either CP or UP protocols as underlying transport. NRPP is terminated between a target device and the LMF. RRC protocol is used between UE and gNB (via NR radio interface) and between UE and ng-eNB (via LTE radio interface).

Furthermore, the NR Positioning Protocol A (NRPPa) carries information between the NG-RAN Node and the LMF and is transparent to the AMF. As such, the AMF routes the NRPPa PDUs transparently (e.g., without knowledge of the involved NRPPa transaction) over NG-C interface based on a Routing ID corresponding to the involved LMF. More specifically, the AMF carries the NRPPa PDUs over NG-C interface either in UE associated mode or non-UE associated mode. The NGAP protocol between the AMF and an NG-RAN node (e.g., gNB or ng-eNB) is used as transport for LPP and NRPPa messages over the NG-C interface. NGAP is also used to instigate and terminate NG-RAN-related positioning procedures.

LPP/NRPP are used to deliver messages such as positioning capability request, OTDOA positioning measurements request, and OTDOA assistance data to the UE from a positioning node (e.g., location server). LPP/NRPP are also used to deliver messages from the UE to the positioning node including, e.g., UE capability, UE measurements for UE-assisted OTDOA positioning, UE request for additional assistance data, UE configuration parameter(s) to be used to create UE-specific OTDOA assistance data, etc. NRPPa is used to deliver the information between ng-eNB/gNB and LMF in both directions. This can include LMF requesting some information from ng-eNB/gNB, and ng-eNB/gNB providing some information to LMF. For example, this can include information about PRS transmitted by ng-eNB/gNB that can be used for OTDOA positioning measurements by the UE.

As briefly mentioned above, network-based positioning reference units (PRUs) are being discussed in 3GPP as a positioning enhancement for Rel-17 and beyond. A PRU is a network node or device, at a known location, which can transmit UL reference signals, perform positioning measurements, and report these measurements to a positioning node (e.g., LMF). In this manner, PRUs can help identify positioning errors and facilitate compensation for these errors in positions determined for UEs that are proximate in the network. From the positioning node's perspective, the PRU is a UE at a known location.

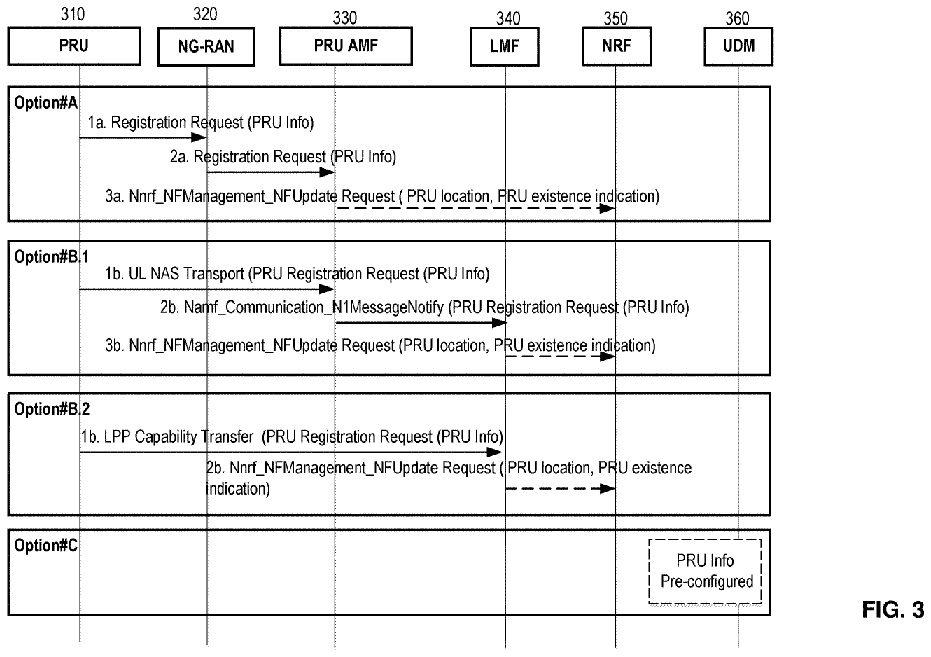

An unresolved technical issue is how PRUs should be registered in a 5G network, such that other network nodes or functions are aware of their existence and capabilities. 3GPP TR 23.700-86 (v2.0.0) discusses various solutions for management of PRUs by the 5G network, including a PRU management procedure used by 5GC to obtain information about PRUs available in the 5G network. FIG. 3 shows signaling diagrams for four different solutions for PRU management, which are described individually below.

In option A, a PRU (310) initiates a registration procedure towards an AMF (330) via an NG-RAN (320) serving the PRU, and includes PRU capabilities and user location information such as cell global identity (CGI) and tracking area identity (TAI). The PRU may also include its mobility state (e.g., mobile or static/fixed) in its registration, so AMF can maintain all the available PRU with related information dynamically. Subsequently, AMF invokes the Nnrf_NFManagement NFUpdate Request (PRU location, PRU existence indication) service operation towards an NRF (350) to indicate PRU existence in certain areas (e.g., in one or multiple TAIs). The NRF maintains this information.

In option B.1, a UE (310) provides an indication to its serving AMF whether it can function as a PRU. The serving AMF then registers the PRU-capable UE to an LMF (340). Subsequently, the LMF invokes the Nnrf_NFManagement NFUpdate Request (PRU location, PRU existence indication) service operation towards the NRF to indicate PRU existence in certain areas (e.g., in one or multiple TAIs). The NRF maintains this information.

In option B.2, which is a variant of option B.1, the LMF obtains available PRU information via LPP procedures, prior to invoking the same NRF service operation as in option B.1.

In option C, a UE (310) may be pre-configured as a PRU (or PRU-capable) with the PRU information included in the UE subscription data stored in the unified data management function (UDM, 360) in 5GC, e.g., as a new parameter set.

Returning to option B.1, the AMF may verify that the sender of the PRU Registration Request is a PRU, using subscription information obtained from the UDM. The AMF then selects the serving LMF based on the PRU's current TAI and transfers the PRU Registration Request to the serving LMF using an Namf_Communication_NIMessageNotify service operation, including the PRU's subscription permanent identifier (SUPI) and an indication that the PRU was verified by the AMF. The serving LMF authenticates the PRU, which can be based on the indication received from AMF or on matching the received SUPI to a corresponding SUPI stored by LMF.

All of the above-described options involve storing PRU information (including location) in the NRF. However, this violates some general policies for usage of NRF. For example, NRF is generally expected to handle static storage and is not designed to handle frequently updated information. Even if a PRU's location is known, it may also change as the PRU (as a UE) moves around the network. This may occur frequently since there are no restrictions on PRU movement. In such case, the PRU's information stored in NRF would need to be updated frequently, which violates policies on NRF usage.

Recently, 3GPP defined some use cases and requirements for sensing in 3GPP TR 22.837 (v0.3.0) and has defined study items to identify use cases and architectural enhancements that will enable joint communications and sensing (JCAS) in cellular networks. In this context, the general goal of sensing is to detect and localize a target that is not necessarily connected to the network, such as a pedestrian, an animal, an object, etc.

The 3GPP study is directed to defining a 5G end-to-end Harmonized Communication and Sensing (HCS) architecture to enable sensing services, and includes the following objectives:
Gap analysis of the existing 5GS architecture and functionalities for the support of HCS service.
Study E2E architecture enhancements required to support new sensing service, including:
   Overall HCS architecture, e.g., whether new network functions, interfaces, and/or protocols are needed;
   RAN and CN functional split to support sensing service.
   End-to-end (E2E) signaling interactions to support sensing service including sensing control and sensing reporting among UE, RAN, core network (CN), and application functions (AF).
   Sensing service authorization and exposure.

In general, sensing involves the network transmitting radio signals and receiving/measuring versions of those signals that have been reflected by the target (and possibly other surroundings). The transmitting and receiving can be performed by the same node(s) or by different node(s). Processing output of the sensing measurements yields information of the target and its surroundings that the radio signals interacted with, possibly including sources of attenuation, reflection, refraction, etc.

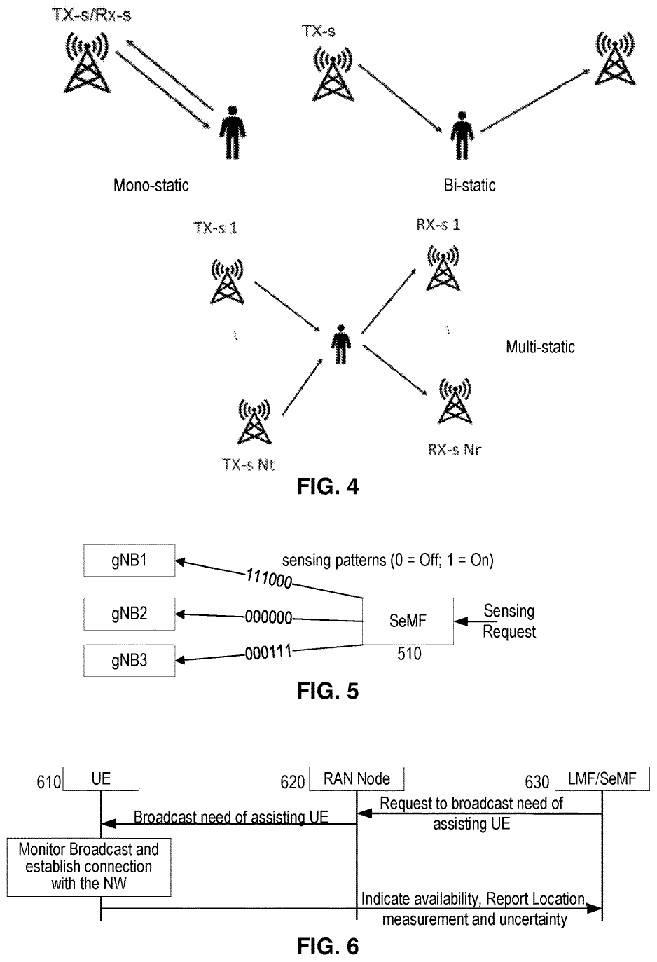

FIG. 4 illustrates three different sensing techniques that can be used in a cellular network. In the upper left, mono-static sensing involves the same node (or antenna) transmitting the sensing signals and receiving/measuring the reflected versions. In the upper right, bi-static sensing involves a first node (or antenna) transmitting the sensing signals and a second node (or antenna) at a different location receiving/measuring the reflected versions. At the bottom, multi-static sensing involves multiple first nodes (or antennas) at different locations transmitting the sensing signals and multiple second nodes (or antennas) at other different locations receiving/measuring the reflected versions.

In any of these cases, the receiver may perform one or more of the following sensing measurements on the received sensing signals:
Timing measurement (e.g., round-trip time, TOA, Rx-Tx time difference, etc.) of the signal (time when signal was sent+time when the reflected signal was received by the sender)
Signal strength, signal quality, signal-to-noise ratio, etc.
Phase measurement;
Channel impulse response, multipath characteristics, power delay profile;
Delay spread, Doppler spectra, Doppler spread, Doppler shift, Doppler frequency,
Velocity, Angle of arrival, angle of departure.

These various measurements can be processed to obtain information about the target and its surroundings that affected the transmitted sensing signals, including one or more of the following:
Characteristics (shape, size, number, etc.) of target and/or obstacles;
Velocity of target and/or obstacles;
Weather conditions (e.g., rain);
Recognition of objects (e.g., wall, blocker, scatterer, etc.).

A sensing request may originate from applications external to the network. 3GPP has defined a Sensing Management Function (SeMF) to handle these requests and to trigger the necessary sensing operations in the RAN, including any UEs that have capability to assist with the sensing. SeMF is a logical entity that resides in the RAN (e.g., gNB) or in 5GC (e.g., a NF).

In general, the SeMF should be able to determine which nodes (e.g., gNBs, sensing units, UEs, etc.) should enable their sensing function for a given sensing request. If the same sensing request comes from multiple sources, the SeMF should reuse sensing information to satisfy all of these requests. The SeMF should be able to collect and aggregate measurements from multiple sensing nodes and provide them to a single processing unit.

The SeMF should also be to configure sensing patterns for nodes (e.g., gNBs, sensing units, UEs, etc.) and collaborate with these nodes to configure or coordinate transmissions and/or receptions of the necessary sensing signals, while avoiding or minimizing interference (e.g., in case of bi- or multi-static sensing). FIG. 5 shows a simplified example that illustrates how an SeMF (510) can control sensing patterns for three gNBs. The SeMF provides each gNB with a six-bit pattern, with each bit associated with a different sensing period. A value of “1” in a bit indicates the receiving gNB should activate sensing during the associated sensing period, while a value of “0” in a bit indicates that the receiving gNB should deactivate sensing during the associated sensing period.

The SeMF will need to obtain information about sensing target(s) and sensing participants associated with a request, such as accurate position, synchronization level, orientation, velocity (e.g., 6D), environment type (e.g., indoor/outdoor, stationary/moving, etc.). This information may be obtained on demand, e.g., from UE(s) in the target area, from RAN nodes, from sensing UEs, etc.). This information can be used as sensing assistance information to facilitate sensing configuration (e.g., antenna configuration, radio signal configuration, participant selection, receiver configuration, measurement configuration), performing measurements, and measurement processing.

The SeMF may need to handle prioritization and scheduling of sensing measurements and their processing. For sensing units that are actively communicating, the SeMF needs to find periods (e.g., timeslots) that can be used for sensing. Alternately, the SeMF may instruct these active sensing units to insert sensing signals (e.g., reference signals) into their transmitted communication signals, or to expect sensing signals in their received communication signals. Additionally, the SeMF may coordinate and support the synchronization mechanism for gNBs or sensing units required by bi- or multi-static sensing.

To support this functionality, the SeMF needs to be aware of which sensing-capable UEs are available in a given area. One option is to store such information in NRF in a similar manner as for PRUs, discussed above. Even so, similar problems may occur when information about sensing capable UEs is stored in NRF, since locations of these UEs may also change frequently.

Accordingly, embodiments of the present disclosure address these and other problems, issues, and/or difficulties by providing techniques for LMF (or SeMF) to obtain available PRUs (or sensing UEs) without the network having to maintain a database of such information. For example, when LMF requires a PRU from a cell, it requests the serving gNB to enable a flag (or bit) in existing broadcast system information (e.g., in SIB1) or to initiate broadcast of a system information block (SIB) containing such information. The SIB may include one or more of the following:
PRUs needed flag (yes/no)
Requesting LMF ID, Routing Identifier
Thresholds for signal strength (RSRP), signal quality (RSRQ), and/or line-of-sight (LOS) to serving gNB;
Requested measurements (e.g., RSTD, RSRP, measurement uncertainty, location);
Requested (or needed) duration of measurements by PRUs.

Upon reading the SIB and determining that it can meet any included requirements (e.g., thresholds), a PRU initiates a connection towards the LMF and informs the LMF of its availability and/or capabilities. As another example, similar techniques can be used for SeMF to indicate requirement for sensing UEs.

Embodiments can provide various technical benefits and/or advantages. For example, as mentioned above, embodiments may enable LMF/SeMF to identify available UEs without maintaining a database (e.g., in NRF) that needs to be frequently updated as UEs move. Moreover, embodiments may enable more timely identification of available UEs than other solutions that require LMF-to-LMF interactions. Each LMF may efficiently identify available UEs in its served area. Moreover, embodiments may facilitate deployment of “assisting” UEs that can identify themselves as sensing UEs and/or PRUs, but can utilize thresholds, etc. to avoid the LMF/SeMF receiving too many offers from such assisting UEs.

As used herein, the term “assisting UE” (or “assistant UE”) refers to any UE that is capable of assisting with sensing and/or positioning operations performed in a communication network (e.g., by network nodes or functions), particularly operations in which the assisting UE is not a target (i.e., another UE or object is the target). PRUs and sensing (or sensing capable) UEs are examples of assisting UEs, with those examples being used sometimes in the following description to illustrate features applicable to all assisting UEs.

FIG. 6 shows a signaling diagram according to some embodiments of the present disclosure. In particular, FIG. 6 shows signaling between a UE (610), a RAN node (620, e.g., gNB), and an LMF/SeMF (630). In various embodiments, the LMF/SeMF may have one or both of these functionalities, depending on whether PRUs and/or sensing UEs are needed.

As a pre-condition to performing the operations in FIG. 6, the LMF/SeMF determines a need for one or more assisting UEs to perform sensing or positioning tasks with respect to a target (e.g., object or other UE). The LMF/SeMF then sends a request for the RAN node to broadcast a message (i.e., in the cells served by the RAN node) indicating the LMF/SeMF's need for assisting UEs, which the RAN node performs according to the request. For example, the information can be broadcast in an existing SIB (e.g., SIB1) or in a newly-defined SIB. In either case, the SIB may include one or more of the following:
Assisting UEs needed flag (yes/no)
Requesting LMF/SeMF ID, Routing Identifier
Thresholds for signal strength (RSRP), signal quality (RSRQ), and/or line-of-sight (LOS) to serving gNB;
Requested measurements (e.g., RSTD, RSRP, measurement uncertainty, location);
Requested (or needed) duration of measurements by assisting UEs.

UEs in non-connected states (e.g., RRC_IDLE, RRC_INACTIVE) in these cells monitor the broadcasts by the RAN node. Upon reading the SIB and determining that it can meet any included requirements (e.g., thresholds), an assisting UE initiates a connection towards the LMF/SeMF (if not already in RRC_CONNECTED state) and informs the LMF/SeMF of its availability and/or capabilities.

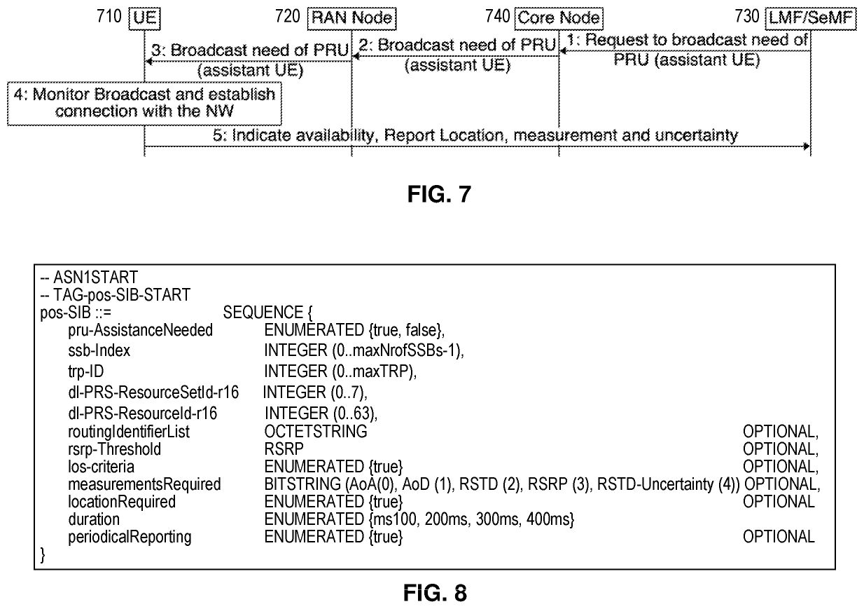

FIG. 7 shows a signaling diagram according to other embodiments of the present disclosure. In particular, FIG. 7 shows signaling between a UE (710), a RAN node (720, e.g., gNB), an LMF/SeMF (730), and a core network node (740, e.g., AMF). The primary difference from FIG. 6 is that the LMF/SeMF sends the request to broadcast a message indicating the LMF/SeMF's need for assisting UEs to the core network node, which then forwards it to the RAN node. In some cases, the core network node may forward the request to multiple RAN nodes that are connected to it (e.g., via NG interfaces). The core network node may select these RAN nodes based on their coverage of an area associated with parameters in the request.

The disclosed techniques can also be embodied as text in 3GPP specifications. The following is some example text for 3GPP TS 38.445 (v17.3.0) that specifies how an LMF requests an NG-RAN node to broadcast need for a PRU. This is done as part of an existing NRPPa assistance information control procedure. Note the new “Assistance UE Broadcast Request Information” field.
***Begin 3GPP specification text***

### 9.1.3.1 Assistance Information Control

This message is sent by the LMF to transfer assistance information.
Direction: LMF→NG-RAN Node.

| IE/Group Name | Pres. | Range | IE type/ref. | Semantics description |
|---|---|---|---|---|
| Message Type | M | | 9.2.3 | |
| NRPPa Transaction | M | | 9.2.4 | |
| ID | | | | |
| Assistance | O | | 9.2.19 | |
| Information | | | | |
| Broadcast | O | | ENUMERATED | |
| | | | (start, stop, . . . ) | |
| Positioning | O | | 9.2.59 | The cell(s) that are |
| Broadcast Cells | | | | requested to broadcast |
| | | | | posSIB(s) according to the |
| | | | | Assistance Information IE. |
| Assistance UE | O | | 9.2.X | |
| Broadcast Request | | | | |
| Information | | | | |

### 9.2.X Assistance UE Broadcast Request Information

This IE contains the assistance information to broadcast in SIB to request the assistance UE to connect to the network.

| IE/Group Name | Pres. | IE type/ref. | Semantics description |
|---|---|---|---|
| PRU needed | M | ENUMERATED | |
| | | (true, false) | |
| SSB-Index | O | INTEGER(0 . . . 63) | |
| TRP ID | O | INTEGER(0 . . . 65535) | |
| PRS-Resource-Set-ID | O | INTEGER(0 . . . 7) | |
| PRS-Resource-ID | O | INTEGER(0 . . . 63) | |
| LMF ID | O | BITSTRING/ | ID of LMF |
| | | OCTETSTRING | |
| Routing ID | O | OCTET STRING | This IE is used to identify an LMF |
| | | | within the 5GC. |
| | | | The maximum length is 16 octets, |
| | | | corresponding to the binary form |
| | | | of NfInstanceId defined in TS |
| | | | 29.571 [35] |
| RSRP threshold | M | INTEGER (0 . . . 127) | |
| LoS criteria | | ENUMERATED | |
| | | (true, . . . ) | |
| Measurement required | O | BITSTRING(8) | Each bit in the bitmap corresponds |
| | | | to a requested measurement. |
| | | | First bit: AoA |
| | | | Second bit AoD |
| | | | Third bit RSTD |
| | | | Fourth bit RSRP |
| | | | Fifth bit: RSTD Uncertainty |
| | | | Other bits reserved or future use |
| Location requested | O | ENUMERATED | |
| | | (true, . . . ) | |
| Time duration | M | ENUMERETED | |
| | | (ms 100, 200 ms, | |
| | | 300 ms, 400 ms) | |
| Periodical reporting | O | ENUMERATED | |
| | | (true, . . . ) | |

*** End 3GPP specification text ***

Alternately, a new NRPPa message from LMF to gNB can be defined to carry the Assistance UE Broadcast Request Information request.

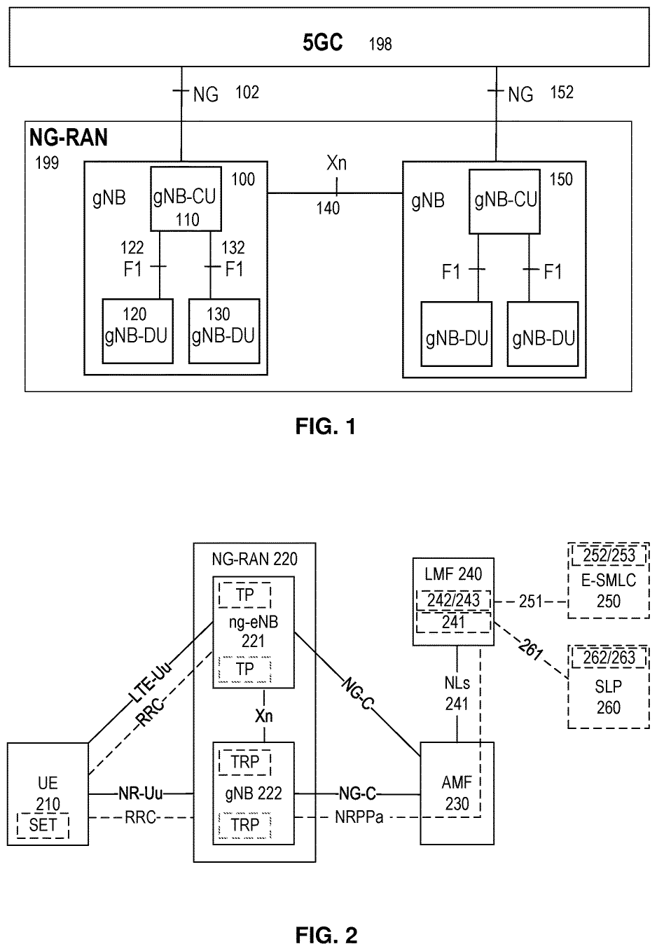

In embodiments where the gNB uses the split-node architecture illustrated in FIG. 1, the CU receives the request from LMF (optionally via CN node) and sends a corresponding message over the F1 interfaces to one or more of its DUs. Each F1 message includes the information received from LMF to be broadcast in SIBs by the DU. For example, the F1 message POSITIONING ASSISTANCE INFORMATION CONTROL defined in 3GPP TS 38.473 (v17.3.0) can be used for this purpose. FIG. 8 shows an example ASN.1 data structure according to these embodiments, with the fields defined as follows:
pru-AssistanceNeeded—This bit is set to true when PRU Assistance is required by the Location Server. If a dedicated SIB for PRU is used, then this indication can be implicit based upon whether the dedicated system info for PRU is being broadcast or not.
ssb-Index—Indicates the SSB index from where PRU measurements are needed. Thus PRUs present in that SSB index (best SSB beam) should respond. The NW may also provide RSRP criteria and thus only PRU UEs above that RSRP threshold for that SSB index should respond. This may also be applied for CSI-RS, DL-PRS.
trp-ID—Indicates the TRP ID transmissing PRS from where the PRU measurements are needed if RSRP threshold is above certain crietria.
dl-PRSResourceSet—Indicates that the PRU UE measurement from this resource set is needed. The NW may also provide RSRP criteria and thus only PRU UEs above that RSRP threshold for that Resource set should respond.
dl-PRSResource—Indicates that the PRU UE measurement from this resource is needed. The NW may also provide RSRP criteria and thus only PRU UEs above that RSRP threshold for that resource should respond.
routingIdentifierList—Indicates the routing Identity that the PRU shall use when connecting to AMF so that the AMF can identify the correct LMF. It is possible that multiple LMF may request the PRU measurements from a cell, in such case multiple routing identifier can be included in the broadcast.
rsrpThreshold—Indicates the criteria for a PRU to be suitable for providing the necessary measurement report to the Network based upon RSRP Threshold.
los-criteria—Indicates the criteria for a PRU to be suitable for providing the necessary measurement report to the Network based upon line of sight conditions. This can be also provided based upon LOS probability. If UE can determine, it has probability to be LOS by more than certain percentage then only it shall respond.
measurementRequired—Contains list of measurements that are required to be included.
duration—Indicates for how long the PRU support is expected to be provided. If periodical reporting is set to true, the duration field may indicate a reporting period.
periodicalReporting—Indicates if periodical reporting from PRUs is needed.

While the ASN.1 data structure shown in FIG. 8 is described above as an F1 message from CU to DU, it should be understood the same or similar fields can be included in the message from LMF/SeMF to RAN node (optionally via CN node) requesting broadcast, as shown in FIGS. 6-7.

In other embodiments, instead of using a broadcast SIB, the RAN node can trigger the same UE behavior based on transmitting a specific reference signal (RS) in a cell, e.g., a specific positioning RS (PRS). The RS transmission may be triggered by a request from LMF/SeMF, in a similar manner as shown in FIGS. 6-7. The RAN node may refrain from transmitting the specific RS when there is no need for assisting UEs. In some embodiments, the specific RS may be associated with a measurement to be performed by an assisting UE. If an assisting UE detects the specific RS, it can directly initiate the measurement and reporting of the measurement results (and possibly also UE location) to the network.

In some embodiments, the LMF/SeMF may send the request based on determining that no stationary assisting UEs are available. This could be done, for example, by inquiring to an NRF that stores information about the availability of stationary UEs available in specific areas, e.g., in each tracking area of the network.

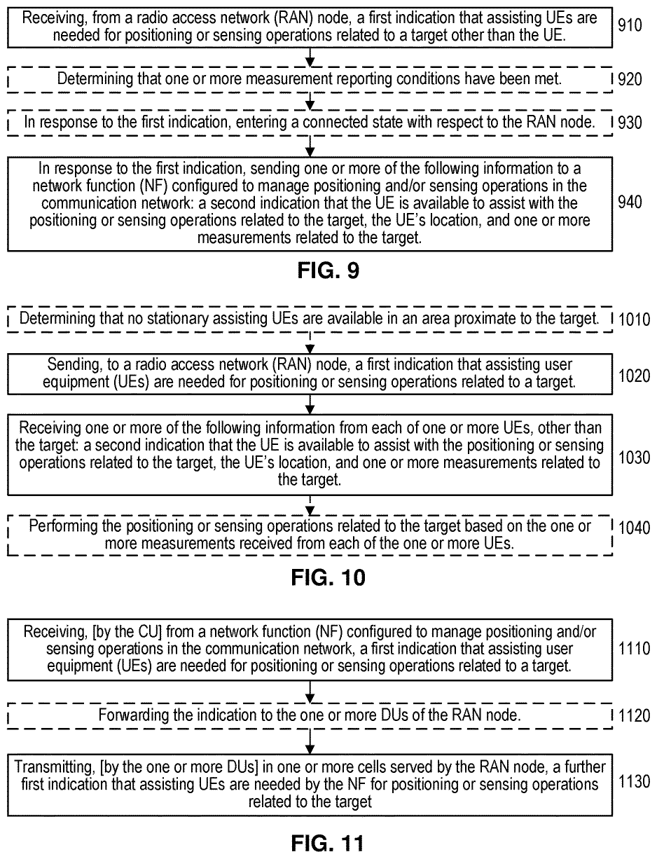

Various features of the embodiments described above correspond to various operations illustrated in FIGS. 9-11, which show exemplary methods (e.g., procedures) for a UE, a network function (NF), and a RAN node, respectively. In other words, various features of the operations described below correspond to various embodiments described above. Furthermore, the exemplary methods shown in FIGS. 9-11 can be used cooperatively to provide various benefits, advantages, and/or solutions to problems described herein. Although FIGS. 9-11 show specific blocks in particular orders, the operations of the exemplary methods can be performed in different orders than shown and can be combined and/or divided into blocks having different functionality than shown. Optional blocks or operations are indicated by dashed lines.

In particular, FIG. 9 shows an exemplary method (e.g., procedure) for a UE configured to assist with positioning and/or sensing operations in a communication network, according to various embodiments of the present disclosure. The exemplary method can be performed by a UE (e.g., wireless device, etc.) such as described elsewhere herein.

The exemplary method includes the operations of block 910, where the UE receives, from a RAN node, a first indication that assisting UEs are needed for positioning or sensing operations related to a target other than the UE. The exemplary method also includes the operations of block 950, where in response to the first indication, the UE sends one or more of the following information to an NF configured to manage positioning and/or sensing operations in the communication network: a second indication that the UE is available to assist with the positioning or sensing operations related to the target, the UE's location, and one or more measurements related to the target.

In some embodiments, the first indication is received in a system information block (SIB) broadcast by the RAN node in a cell in which the UE is located. In other embodiments, the first indication is received as a reference signal (RS) transmitted by the RAN node. In some embodiments, the first indication is received while the UE is in a non-connected state with respect to the RAN, and the exemplary method also includes the operations of block 930, where in response to the first indication, the UE enters a connected state with respect to the RAN, after which the information is sent to the NF in block 940.

In some embodiments, the first indication is received together with one or more of the following: an address or identifier associated with the NF, one or more measurement reporting conditions for assisting UEs, and configuration of requested measurements. In some of these embodiments, the measurement reporting conditions include one or more of the following: area of interest, minimum downlink (DL) signal strength, minimum DL signal quality, and line-of-sight (LOS) from assisting UE to RAN node.

In some of these embodiments, the configuration of requested measurements includes one or more of the following: measurement type, one or more identifiers associated with RS to be measured, measurement duration, need for measurement uncertainty, need for UE location, and need for periodic measurement reporting. In some variants of these embodiments, the one or more identifiers associated with RS to be measured include one or more of the following: index of a synchronization signal/PBCH (SSB) to be measured, identifier of a transmission/reception point (TRP) that transmits a RS to be measured, identifier of a positioning reference signal (PRS) resource set to be measured, and identifier of a PRS resource to be measured.

In some of these embodiments, the information sent to the NF is based on one or more of the following: determining in block 920 that the one or more measurement reporting conditions have been met, and the configuration of requested measurements.

In some embodiments, the second indication and the one or more measurements are sent in a single message. In other embodiments, the second indication is sent in a first message and the one or more measurements are sent in a subsequent second message.

In some embodiments, the UE is a PRU and the NF is an LMF in a 5GC. In other embodiments, the UE is a sensing UE and the NF is an SeMF in a 5GC.

In addition, FIG. 10 shows an exemplary method (e.g., procedure) for an NF configured to manage positioning and/or sensing operations in a communication network, according to various embodiments of the present disclosure. The exemplary method can be performed by an LMF, an SeMF, or similar NF, such as described elsewhere herein.

The exemplary method includes the operations of block 1020, where the NF transmits, to a RAN node, a first indication that assisting UEs are needed for positioning or sensing operations related to a target. The exemplary method also includes the operations of block 1030, where the NF subsequently receives (e.g., via the RAN node) one or more of the following information from each of one or more UEs, other than the target: a second indication that the UE is available to assist with the positioning or sensing operations related to the target, the UE's location, and one or more measurements related to the target.

In some embodiments, the first indication is sent in a request to broadcast the indication in one or more cells served by the RAN node. In other embodiments, the first indication is sent in a request for the RAN node to transmit a RS associated with the requested positioning or sensing operations. In some embodiments, the first indication is sent to the RAN node using a point-to-point protocol between the NF and the RAN node. In other embodiments, the first indication is sent to a core network node for forwarding to the RAN node.

In some embodiments, the first indication is sent together with one or more of the following: an address or identifier associated with the NF, one or more measurement reporting conditions for assisting UEs, and configuration of requested measurements. In some of these embodiments, the measurement reporting conditions include one or more of the following: area of interest, minimum DL signal strength, minimum DL signal quality, and LOS from assisting UE to RAN node.

In some of these embodiments, the configuration of requested measurements includes one or more of the following: measurement type, one or more identifiers associated with RS to be measured, measurement duration, need for measurement uncertainty, need for UE location, and need for periodic measurement reporting. In some variants of these embodiments, the one or more identifiers associated with RS to be measured include one or more of the following: index of an SSB to be measured, identifier of a TRP that transmits a RS to be measured, identifier of a PRS resource set to be measured, and identifier of a PRS resource to be measured.

In some of these embodiments, the information received from each of the one or more UEs is based on one or more of the following: the UE determining that the measurement reporting conditions are met, and the configuration of requested measurements.

In some embodiments, the second indication and the one or more measurements are received in a single message. In other embodiments, the second indication is received in a first message and the one or more measurements are received in a subsequent second message.

In some embodiments, the exemplary method also includes the operations of block 1040, where the NF performs the positioning or sensing operations related to the target based on the one or more measurements received from each of the one or more UEs. In some embodiments, sending the first indication to the RAN node in block 1020 is based on the operations in block 1010, where the NF determines that no stationary assisting UEs are available in an area proximate to the target.

In some embodiments, the UE is a PRU and the NF is an LMF in a 5GC. In other embodiments, the UE is a sensing UE and the NF is an SeMF in a 5GC.

In addition, FIG. 11 shows an exemplary method (e.g., procedure) for a RAN node configured to facilitate positioning and/or sensing operations in a communication network, according to various embodiments of the present disclosure. The exemplary method can be performed by a RAN node (e.g., base station, eNB, gNB, en-gNB, etc.) or units thereof (e.g., CU, DU), such as described elsewhere herein.

The exemplary method includes the operations of block 1110, where the RAN node receives, from an NF configured to manage positioning and/or sensing operations in the communication network, a first indication that assisting UEs are needed for positioning or sensing operations related to a target. The exemplary method also includes the operations of block 1130, where the RAN node transmits, in one or more cells served by the RAN node, a further first indication that assisting UEs are needed by the NF for the positioning or sensing operations related to the target.

In some embodiments, the first indication is received as a request to broadcast the indication in one or more cells served by the RAN, and the further first indication is transmitted in a SIB broadcast by the RAN node in the one or more cells. In other embodiments, the first indication is received in a request for the RAN node to transmit a RS associated with the positioning or sensing operations related to the target, and the further first indication is transmitted as the RS associated with the positioning or sensing operations. In some embodiments, the first indication is received from the NF using a point-to-point protocol between the NF and the RAN node. In other embodiments, the first indication is received via a core network node coupled to the RAN node.

In some embodiments, the first indication is received, and the further first indication is transmitted, together with one or more of the following: an address or identifier associated with the NF, one or more measurement reporting conditions for assisting UEs, and a configuration of requested measurements. In some of these embodiments, the measurement reporting conditions include one or more of the following: area of interest, minimum DL signal strength, minimum DL signal quality, and LOS from assisting UE to RAN node.

In some of these embodiments, the configuration of requested measurements includes one or more of the following: measurement type, one or more identifiers associated with RS to be measured, measurement duration, need for measurement uncertainty, need for UE location, and need for periodic measurement reporting. In some variants of these embodiments, one or more identifiers associated with RS to be measured include one or more of the following: index of an SSB to be measured, identifier of a TRP that transmits a PRS to be measured, identifier of a PRS resource set to be measured, and identifier of a PRS resource to be measured.

In some embodiments, the RAN node comprises a centralized unit (CU) and one or more distributed units (DUs). In such embodiments, receiving the first indication (e.g., in block 1110) is performed by the CU and transmitting the further first indication in the one or more cells (e.g., in block 1130) is performed by the one or more DUs. Also, the exemplary method also includes the operations of block 1120, where the CU forwards the first indication to the one or more DUs.

In some embodiments, the UE is a PRU and the NF is an LMF in a 5GC. In other embodiments, the UE is a sensing UE and the NF is an SeMF in a 5GC.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

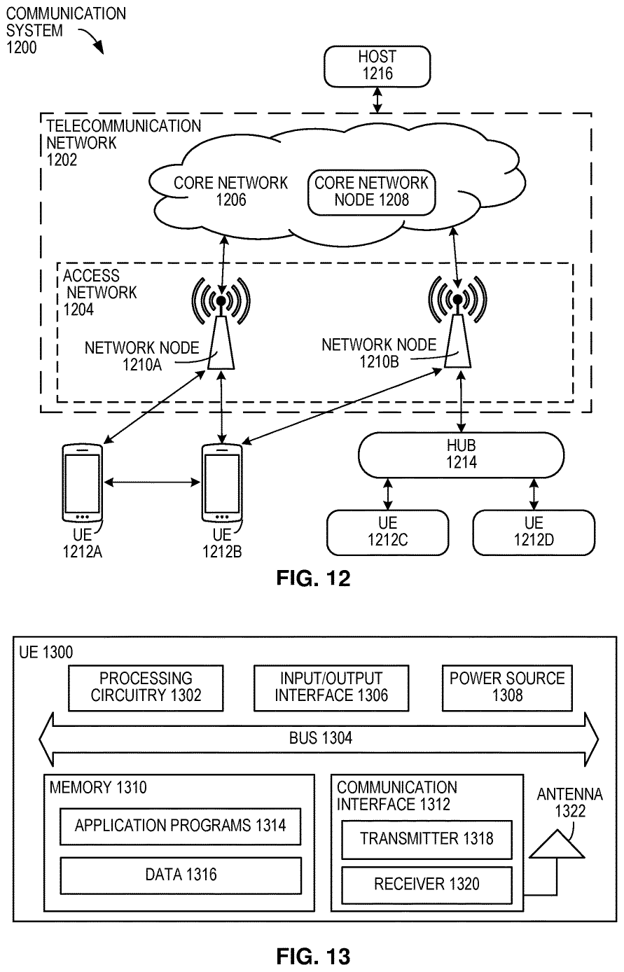

FIG. 12 shows an example of a communication system 1200 in accordance with some embodiments. In this example, communication system 1200 includes telecommunication network 1202 that includes access network 1204 (e.g., RAN) and core network 1206, which includes one or more core network nodes 1208. Access network 1204 includes one or more access network nodes, such as network nodes 1210a-b (one or more of which may be generally referred to as network nodes 1210), or any other similar 3GPP access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, telecommunication network 1202 includes one or more Open-RAN (ORAN) network nodes. An ORAN network node is a node in telecommunication network 1202 that supports an ORAN specification (e.g., a specification published by the O-RAN Alliance, or any similar organization) and may operate alone or together with other nodes to implement one or more functionalities of any node in telecommunication network 1202, including one or more network nodes 1210 and/or core network nodes 1208.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. Network nodes 1210 facilitate direct or indirect connection of UEs, such as by connecting UEs 1212a-d (one or more of which may be generally referred to as UEs 1212) to core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1200 may include any number of wired or wireless networks, network nodes, UEs, and/or any other components or systems that may facilitate or participate in the communication of data and/or signals whether via wired or wireless connections. Communication system 1200 may include and/or interface with any type of communication, telecommunication, data, cellular, radio network, and/or other similar type of system.

UEs 1212 may be any of a wide variety of communication devices, including wireless devices arranged, configured, and/or operable to communicate wirelessly with network nodes 1210 and other communication devices. Similarly, network nodes 1210 are arranged, capable, configured, and/or operable to communicate directly or indirectly with UEs 1212 and/or with other network nodes or equipment in telecommunication network 1202 to enable and/or provide network access, such as wireless network access, and/or to perform other functions, such as administration in telecommunication network 1202.

In the depicted example, core network 1206 connects network nodes 1210 to one or more hosts, such as host 1216. These connections may be direct or indirect via one or more intermediary networks or devices. In other examples, network nodes may be directly coupled to hosts. Core network 1206 includes one or more core network nodes (e.g., 1208) that are structured with hardware and software components. Features of these components may be substantially similar to those described with respect to the UEs, network nodes, and/or hosts, such that the descriptions thereof are generally applicable to the corresponding components of core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), Location Management Function (LMF), Sensing Management Function (SeMF), and/or User Plane Function (UPF).

In some embodiments, network node 1210 may be configured to perform operations attributed to a RAN node in the above descriptions of various methods or procedures, such as in relation to FIGS. 6-7 and 9-11. Likewise, core network node 1208 may be configured to perform operations attributed to an NNF (e.g., LMF, SeMF) in these descriptions. Likewise, any of UEs 1212 may be configured to perform operations attributed to a UE in these descriptions.

Host 1216 may be under the ownership or control of a service provider other than an operator or provider of access network 1204 and/or telecommunication network 1202, and may be operated by the service provider or on behalf of the service provider. Host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1202 is a cellular network that implements 3GPP standardized features. Accordingly, telecommunication network 1202 may support network slicing to provide different logical networks to different devices that are connected to telecommunication network 1202. For example, telecommunication network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1212 are configured to transmit and/or receive information without direct human interaction. For instance, a UE may be designed to transmit information to access network 1204 on a predetermined schedule, when triggered by an internal or external event, or in response to requests from access network 1204. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, hub 1214 communicates with access network 1204 to facilitate indirect communication between one or more UEs (e.g., 1212c and/or 1212d) and network nodes (e.g., network node 1210b). In some examples, hub 1214 may be a controller, router, content source and analytics, or any of the other communication devices described herein regarding UEs. For example, hub 1214 may be a broadband router enabling access to core network 1206 for the UEs. As another example, hub 1214 may be a controller that sends commands or instructions to one or more actuators in the UEs. Commands or instructions may be received from the UEs, network nodes 1210, or by executable code, script, process, or other instructions in hub 1214. As another example, hub 1214 may be a data collector that acts as temporary storage for UE data and, in some embodiments, may perform analysis or other processing of the data. As another example, hub 1214 may be a content source. For example, for a UE that is a VR headset, display, loudspeaker or other media delivery device, hub 1214 may retrieve VR assets, video, audio, or other media or data related to sensory information via a network node, which hub 1214 then provides to the UE either directly, after performing local processing, and/or after adding additional local content. In still another example, hub 1214 acts as a proxy server or orchestrator for the UEs, in particular if one or more of the UEs are low energy IoT devices.

Hub 1214 may have a constant/persistent or intermittent connection to network node 1210b. Hub 1214 may also allow for a different communication scheme and/or schedule between hub 1214 and UEs (e.g., 1212c and/or 1212d), and between hub 1214 and core network 1206. In other examples, hub 1214 is connected to core network 1206 and/or one or more UEs via a wired connection. Moreover, hub 1214 may be configured to connect to an M2M service provider over access network 1204 and/or to another UE over a direct connection. In some scenarios, UEs may establish a wireless connection with network nodes 1210 while still connected via hub 1214 via a wired or wireless connection. In some embodiments, hub 1214 may be a dedicated hub—that is, a hub whose primary function is to route communications to/from the UEs from/to network node 1210b. In other embodiments, hub 1214 may be a non-dedicated hub—that is, a device which is capable of operating to route communications between the UEs and network node 1210b, but which is additionally capable of operating as a communication start and/or end point for certain data channels.

FIG. 13 shows a UE 1300 in accordance with some embodiments. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1300 includes processing circuitry 1302 that is operatively coupled via bus 1304 to input/output interface 1306, power source 1308, memory 1310, communication interface 1312, and possibly one or more other components not explicitly shown. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

Processing circuitry 1302 is configured to process instructions and data and may be configured to implement any sequential state machine operative to execute instructions stored as machine-readable computer programs in memory 1310. Processing circuitry 1302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1302 may include multiple central processing units (CPUs).

In the example, input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1308 is structured as a battery or battery pack. Other types of power sources, such as an external power source (e.g., an electricity outlet), photovoltaic device, or power cell, may be used. Power source 1308 may further include power circuitry for delivering power from power source 1308 itself, and/or an external power source, to the various parts of UE 1300 via input circuitry or an interface such as an electrical power cable. Delivering power may be, for example, for charging power source 1308. Power circuitry may perform any formatting, converting, or other modification to the power from power source 1308 to make the power suitable for the respective components of UE 1300 to which power is supplied.

Memory 1310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1310 includes one or more application programs 1314, such as an operating system, web browser application, a widget, gadget engine, or other application, and corresponding data 1316. Memory 1310 may store, for use by UE 1300, any of a variety of various operating systems or combinations of operating systems.

Memory 1310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1310 may allow UE 1300 to access instructions, application programs and the like, stored on transitory or non-transitory memory media, to off-load data, or to upload data. An article of manufacture, such as one utilizing a communication system may be tangibly embodied as or in memory 1310, which may be or comprise a device-readable storage medium.

Processing circuitry 1302 may be configured to communicate with an access network or other network using communication interface 1312. Communication interface 1312 may comprise one or more communication subsystems and may include or be communicatively coupled to an antenna 1322. Communication interface 1312 may include one or more transceivers used to communicate, such as by communicating with one or more remote transceivers of another device capable of wireless communication (e.g., another UE or a network node in an access network). Each transceiver may include a transmitter 1318 and/or a receiver 1320 appropriate to provide network communications (e.g., optical, electrical, frequency allocations, and so forth). Moreover, transmitter 1318 and/or receiver 1320 may be coupled to one or more antennas (e.g., 1322) and may share circuit components, software or firmware, or alternatively be implemented separately.

In the illustrated embodiment, communication functions of communication interface 1312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1300 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

In some embodiments, UE 1300 may be configured to perform operations attributed to a UE in the above descriptions of various methods or procedures, such as in relation to FIGS. 6-7 and 9-11.

FIG. 14 shows a network node 1400 in accordance with some embodiments. Examples of network nodes include, but are not limited to, access points (APs) (e.g., radio access points), base stations (e.g., radio base stations, Node Bs, eNBs, gNBs), and O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1400 includes processing circuitry 1402, memory 1404, communication interface 1406, and power source 1408. Network node 1400 may be composed of multiple physically separate components (e.g., a NodeB component and a RNC component, or a BTS component and a BSC component, etc.), which may each have their own respective components. In certain scenarios in which network node 1400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1400 may be configured to support multiple radio access technologies (RATs). In such embodiments, some components may be duplicated (e.g., separate memory 1404 for different RATs) and some components may be reused (e.g., a same antenna 1410 may be shared by different RATs). Network node 1400 may also include multiple sets of the various illustrated components for different wireless technologies integrated into network node 1400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1400.

Processing circuitry 1402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1400 components, such as memory 1404, to provide network node 1400 functionality.

In some embodiments, processing circuitry 1402 includes a system on a chip (SOC). In some embodiments, processing circuitry 1402 includes radio frequency (RF) transceiver circuitry 1412 and/or baseband processing circuitry 1414. In some embodiments, RF transceiver circuitry 1412 and/or baseband processing circuitry 1414 may be on separate chips (or sets of chips), boards, or units, such as radio units and digital units. In alternative embodiments, part or all of RF transceiver circuitry 1412 and/or baseband processing circuitry 1414 may be on the same chip or set of chips, boards, or units.

Memory 1404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1402. Memory 1404 may store any suitable instructions, data, or information, including a computer program, software, an application including one or more of logic, rules, code, tables, and/or other instructions (collected denoted computer program 1404a, which may be in the form of a computer program product) capable of being executed by processing circuitry 1402 and utilized by network node 1400. Memory 1404 may be used to store any calculations made by processing circuitry 1402 and/or any data received via communication interface 1406. In some embodiments, processing circuitry 1402 and memory 1404 is integrated.

Communication interface 1406 is used in wired or wireless communication of signaling and/or data between a network node, access network, and/or UE. As illustrated, communication interface 1406 comprises port(s)/terminal(s) 1416 to send and receive data, for example to and from a network over a wired connection. Communication interface 1406 also includes radio front-end circuitry 1418 that may be coupled to, or in certain embodiments a part of, antenna 1410. Radio front-end circuitry 1418 comprises filters 1420 and amplifiers 1422. Radio front-end circuitry 1418 may be connected to an antenna 1410 and processing circuitry 1402. The radio front-end circuitry may be configured to condition signals communicated between antenna 1410 and processing circuitry 1402. Radio front-end circuitry 1418 may receive digital data that is to be sent out to other network nodes or UEs via a wireless connection. Radio front-end circuitry 1418 may convert the digital data into a radio signal having the appropriate channel and bandwidth parameters using a combination of filters 1420 and/or amplifiers 1422. The radio signal may then be transmitted via antenna 1410. Similarly, when receiving data, antenna 1410 may collect radio signals which are then converted into digital data by radio front-end circuitry 1418. The digital data may be passed to processing circuitry 1402. In other embodiments, the communication interface may comprise different components and/or different combinations of components.

In certain alternative embodiments, network node 1400 does not include separate radio front-end circuitry 1418, instead, processing circuitry 1402 includes radio front-end circuitry and is connected to antenna 1410. Similarly, in some embodiments, all or some of RF transceiver circuitry 1412 is part of communication interface 1406. In still other embodiments, communication interface 1406 includes one or more ports or terminals 1416, radio front-end circuitry 1418, and RF transceiver circuitry 1412, as part of a radio unit (not shown), and communication interface 1406 communicates with baseband processing circuitry 1414, which is part of a digital unit (not shown).

Antenna 1410 may include one or more antennas, or antenna arrays, configured to send and/or receive wireless signals. Antenna 1410 may be coupled to radio front-end circuitry 1418 and may be any type of antenna capable of transmitting and receiving data and/or signals wirelessly. In certain embodiments, antenna 1410 is separate from network node 1400 and connectable to network node 1400 through an interface or port.

Antenna 1410, communication interface 1406, and/or processing circuitry 1402 may be configured to perform any receiving operations and/or certain obtaining operations described herein as being performed by the network node. Any information, data and/or signals may be received from a UE, another network node and/or any other network equipment. Similarly, antenna 1410, communication interface 1406, and/or processing circuitry 1402 may be configured to perform any transmitting operations described herein as being performed by the network node. Any information, data and/or signals may be transmitted to a UE, another network node and/or any other network equipment.

Power source 1408 provides power to the various components of network node 1400 in a form suitable for the respective components (e.g., at a voltage and current level needed for each respective component). Power source 1408 may further comprise, or be coupled to, power management circuitry to supply the components of network node 1400 with power for performing the functionality described herein. For example, network node 1400 may be connectable to an external power source (e.g., the power grid, an electricity outlet) via an input circuitry or interface such as an electrical cable, whereby the external power source supplies power to power circuitry of power source 1408. As a further example, power source 1408 may comprise a source of power in the form of a battery or battery pack which is connected to, or integrated in, power circuitry. The battery may provide backup power should the external power source fail.

Embodiments of network node 1400 may include additional components beyond those shown in FIG. 14 for providing certain aspects of the network node's functionality, including any of the functionality described herein and/or any functionality necessary to support the subject matter described herein. For example, network node 1400 may include user interface equipment to allow input of information into network node 1400 and to allow output of information from network node 1400. This may allow a user to perform diagnostic, maintenance, repair, and other administrative functions for network node 1400.

In some embodiments, one or more network nodes 1400 may be configured to perform operations attributed to a RAN node or an NNF (e.g., LMF, SeMF) in the above descriptions of various methods or procedures, such as in relation to FIGS. 6-7 and 9-11.

FIG. 15 is a block diagram of a host 1500, which may be an embodiment of host 1216 of FIG. 12, in accordance with various aspects described herein. As used herein, host 1500 may be or comprise various combinations hardware and/or software, including a standalone server, a blade server, a cloud-implemented server, a distributed server, a virtual machine, container, or processing resources in a server farm. Host 1500 may provide one or more services to one or more UEs.

Host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such as FIGS. 13 and 14, such that the descriptions thereof are generally applicable to the corresponding components of host 1500.

Memory 1512 may include one or more computer programs including one or more host application programs 1514 and data 1516, which may include user data, e.g., data generated by a UE for host 1500 or data generated by host 1500 for a UE. Embodiments of host 1500 may utilize only a subset or all of the components shown. Host application programs 1514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1514 may also provide for user authentication and licensing checks and may periodically report health, routes, and content availability to a central node, such as a device in or on the edge of a core network. Accordingly, host 1500 may select and/or indicate a different host for over-the-top services for a UE. Host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1600 includes components defined by the O-RAN Alliance, such as an O-Cloud environment orchestrated by a Service Management and Orchestration Framework via an O-2 interface.

Applications 1602 (which may alternatively be called software instances, virtual appliances, network functions, virtual nodes, virtual network functions, etc.) are run in the virtualization environment 1600 to implement some of the features, functions, and/or benefits of some of the embodiments disclosed herein. In various embodiments, one or more virtual nodes 1602 can be configured operations to perform operations attributed to a RAN node or an NNF (e.g., LMF, SeMF) in the above descriptions of procedures shown in FIGS. 6-7 and 9-11.

Hardware 1604 includes processing circuitry, memory that stores software and/or instructions (collected denoted computer program 1604a, which may be in the form of a computer program product) executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608a-b (one or more of which may be generally referred to as VMs 1608), and/or perform any of the functions, features and/or benefits described in relation with some embodiments described herein. Virtualization layer 1606 may present a virtual operating platform that appears like networking hardware to the VMs 1608.

VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1608 may be a software implementation of a physical machine that runs programs as if they were executing on a physical, non-virtualized machine. Each VM 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of the hardware 1604 and corresponds to the application 1602.

Hardware 1604 may be implemented in a standalone network node with generic or specific components. Hardware 1604 may implement some functions via virtualization. Alternatively, hardware 1604 may be part of a larger cluster of hardware (e.g. such as in a data center or CPE) where many hardware nodes work together and are managed via management and orchestration function 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1612 which may alternatively be used for communication between hardware nodes and radio units.

FIG. 17 shows a communication diagram of a host 1702 communicating via a network node 1704 with a UE 1706 over a partially wireless connection in accordance with some embodiments. Example implementations, in accordance with various embodiments, of the UE (such as a UE 1212a of FIG. 12 and/or UE 1300 of FIG. 13), network node (such as network node 1210a of FIG. 12 and/or network node 1400 of FIG. 14), and host (such as host 1216 of FIG. 12 and/or host 1500 of FIG. 15) discussed in the preceding paragraphs will now be described with reference to FIG. 17.

Like host 1500, embodiments of host 1702 include hardware, such as a communication interface, processing circuitry, and memory. Host 1702 also includes software, which is stored in or accessible by host 1702 and executable by the processing circuitry. The software includes a host application that may be operable to provide a service to a remote user, such as UE 1706 connecting via an over-the-top (OTT) connection 1750 extending between UE 1706 and host 1702. In providing the service to the remote user, a host application may provide user data which is transmitted using OTT connection 1750.

Network node 1704 includes hardware enabling it to communicate with host 1702 and UE 1706. Connection 1760 may be direct or pass through a core network (like core network 1206 of FIG. 12) and/or one or more other intermediate networks, such as one or more public, private, or hosted networks. For example, an intermediate network may be a backbone network or the Internet.

UE 1706 includes hardware and software, which is stored in or accessible by UE 1706 and executable by the UE's processing circuitry. The software includes a client application, such as a web browser or operator-specific “app” that may be operable to provide a service to a human or non-human user via UE 1706 with the support of host 1702. In host 1702, an executing host application may communicate with the executing client application via OTT connection 1750 terminating at UE 1706 and host 1702. In providing the service to the user, the UE's client application may receive request data from the host's host application and provide user data in response to the request data. OTT connection 1750 may transfer both the request data and the user data. The UE's client application may interact with the user to generate the user data that it provides to the host application through OTT connection 1750.

OTT connection 1750 may extend via a connection 1760 between host 1702 and network node 1704 and via a wireless connection 1770 between network node 1704 and UE 1706 to provide the connection between host 1702 and UE 1706. Connection 1760 and wireless connection 1770, over which OTT connection 1750 may be provided, have been drawn abstractly to illustrate the communication between host 1702 and UE 1706 via network node 1704, without explicit reference to any intermediary devices and the precise routing of messages via these devices.

As an example of transmitting data via OTT connection 1750, in step 1708, host 1702 provides user data, which may be performed by executing a host application. In some embodiments, the user data is associated with a particular human user interacting with UE 1706. In other embodiments, the user data is associated with a UE 1706 that shares data with host 1702 without explicit human interaction. In step 1710, host 1702 initiates a transmission carrying the user data towards UE 1706. Host 1702 may initiate the transmission responsive to a request transmitted by UE 1706. The request may be caused by human interaction with UE 1706 or by operation of the client application executing on UE 1706. The transmission may pass via network node 1704, in accordance with the teachings of the embodiments described throughout this disclosure. Accordingly, in step 1712, network node 1704 transmits to UE 1706 the user data that was carried in the transmission that host 1702 initiated, in accordance with the teachings of the embodiments described throughout this disclosure. In step 1714, UE 1706 receives the user data carried in the transmission, which may be performed by a client application executed on UE 1706 associated with the host application executed by host 1702.

In some examples, UE 1706 executes a client application which provides user data to host 1702. The user data may be provided in reaction or response to the data received from host 1702. Accordingly, in step 1716, UE 1706 may provide user data, which may be performed by executing the client application. In providing the user data, the client application may further consider user input received from the user via an input/output interface of UE 1706. Regardless of the specific manner in which the user data was provided, UE 1706 initiates, in step 1718, transmission of the user data towards host 1702 via network node 1704. In step 1720, in accordance with the teachings of the embodiments described throughout this disclosure, network node 1704 receives user data from UE 1706 and initiates transmission of the received user data towards host 1702. In step 1722, host 1702 receives the user data carried in the transmission initiated by UE 1706.

One or more of the various embodiments improve the performance of OTT services provided to UE 1706 using OTT connection 1750, in which wireless connection 1770 forms the last segment. More precisely, embodiments can enable LMF/SeMF to identify available assisting UEs without maintaining a database (e.g., in NRF) that needs to be frequently updated as UEs move. Moreover, embodiments enable more timely identification of available UEs than other solutions that require LMF-to-LMF interactions. Each LMF can efficiently identify available UEs in its served area. Moreover, embodiments facilitate deployment of assisting UEs that can identify themselves as sensing UEs and/or PRUs, but can utilize thresholds, etc. to avoid the LMF/SeMF receiving too many offers from such assisting UEs. When delivered via networks improved in this manner, OTT services become more valuable to both end users and service providers.

In an example scenario, factory status information may be collected and analyzed by host 1702. As another example, host 1702 may process audio and video data which may have been retrieved from a UE for use in creating maps. As another example, host 1702 may collect and analyze real-time data to assist in controlling vehicle congestion (e.g., controlling traffic lights). As another example, host 1702 may store surveillance video uploaded by a UE. As another example, host 1702 may store or control access to media content such as video, audio, VR or AR which it can broadcast, multicast or unicast to UEs. As other examples, host 1702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 1750 between host 1702 and UE 1706, in response to variations in the measurement results. The measurement procedure and/or the network functionality for reconfiguring the OTT connection may be implemented in software and hardware of host 1702 and/or UE 1706. In some embodiments, sensors (not shown) may be deployed in or in association with other devices through which OTT connection 1750 passes; the sensors may participate in the measurement procedure by supplying values of the monitored quantities exemplified above, or supplying values of other physical quantities from which software may compute or estimate the monitored quantities. The reconfiguring of OTT connection 1750 may include message format, retransmission settings, preferred routing etc.; the reconfiguring need not directly alter the operation of network node 1704. Such procedures and functionalities may be known and practiced in the art. In certain embodiments, measurements may involve proprietary UE signaling that facilitates measurements of throughput, propagation times, latency and the like, by host 1702. The measurements may be implemented in that software causes messages to be transmitted, in particular empty or ‘dummy’ messages, using OTT connection 1750 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the techniques and apparatus described herein also include, but are not limited to, the following enumerated examples:

A1. A method for a user equipment (UE) configured to assist with positioning and/or sensing operations in a communication network, the method comprising:
receiving, from a radio access network (RAN) node, an indication that assisting UEs are needed for positioning or sensing operations relating to a target other than the UE;
in response to the indication, sending one or more of the following information to a network node or function (NNF) configured to manage positioning and/or sensing operations in the communication network:
   a second indication that the UE is available to assist with the requested operations, the UE's location, and
   one or more measurements related to the target.

A2. The method of embodiment A1, wherein the indication is received in a system information block (SIB) broadcast by the RAN node in a cell in which the UE is located.

A3. The method of any of embodiments A1-A2, wherein the indication is received while the UE is in a non-connected state with respect to the RAN, and the method further comprises, in response to the indication, entering a connected state with respect to the RAN, after which the information is sent to the NNF.

A4. The method of embodiment A1, wherein the indication is received as a reference signal (RS) transmitted by the RAN.

A5. The method of any of embodiments A1-A4, wherein the indication is received together with one or more of the following
an address or identifier associated with the measurement collection node;
one or more measurement reporting conditions for assisting UEs; and
configuration of requested measurements.

A6. The method of embodiment A5, wherein the measurement reporting conditions include one or more of the following: area of interest, minimum downlink (DL) signal strength, minimum DL signal quality, and line-of-sight (LOS) from assisting UE to RAN node.

A7. The method of any of embodiments A5-A6, wherein the configuration of requested measurements includes one or more of the following:
measurement type,
one or more identifiers associated with reference signals (RS) to be measured,
measurement duration,
need for measurement uncertainty,
need for UE location, and
need for periodic measurement reporting.

A7a. The method of embodiment A7, wherein the one or more identifiers associated with RS to be measured include one or more of the following: index of a synchronization signal/PBCH (SSB) to be measured, identifier of a transmission/reception point (TRP) that transmits a RS to be measured, identifier of a positioning reference signal (PRS) resource set to be measured, and identifier of a PRS resource to be measured.

A8. The method of any of embodiments A5-A7a, wherein the information sent to the NNF is based on one or more of the following: determining that the one or more measurement reporting conditions have been met, and the configuration of requested measurements.

A9. The method of any of embodiments A1-A8, wherein one of the following applies:
the second indication and the one or more measurements are sent in a single message; or
the second indication is sent in a first message and the one or more measurements are sent in a subsequent second message.

A10. The method of any of embodiments A1-A9, wherein one of the following applies:
the UE is a positioning reference unit (PRU) and the NNF is a location management function (LMF) in a 5G core network (5GC); and
the UE is a sensing UE and the NNF is a sensing management function (SeMF) in a 5GC.

B1. A method for a network node or function (NNF) configured to manage positioning and/or sensing operations in a communication network, the method comprising:
transmitting, to a radio access network (RAN), an indication that assisting user equipment (UEs) are needed for positioning and/or sensing operations in relation to a target; and
subsequently receiving, via the RAN, one or more of the following information from each of one or more UEs, other than the target:
   a second indication that the UE is available to assist with the requested operations,
   the UE's location, and
   one or more measurements related to the target.

B2. The method of embodiment B1, wherein the indication is sent in a request to broadcast the indication in one or more cells served by the RAN.

B3. The method of any of embodiments B1-B2, wherein one of the following applies:
the indication is sent to the RAN using a point-to-point protocol between the measurement collection node and a RAN node; or
the indication is sent to a core network node for forwarding to the RAN.

B4. The method of embodiment B1, wherein the indication is sent in a request for the RAN to transmit a reference signal (RS) associated with the requested positioning or sensing operations.

B5. The method of any of embodiments B1-B4, wherein the indication is sent together with one or more of the following:
an address or identifier associated with the measurement collection node;
one or more measurement reporting conditions for assisting UEs; and
configuration of requested measurements.

B6. The method of embodiment B5, wherein the measurement reporting conditions include one or more of the following: area of interest, minimum downlink (DL) signal strength, minimum DL signal quality, and line-of-sight (LOS) from assisting UE to RAN node.

B7. The method of any of embodiments B5-B6, wherein the configuration of requested measurements includes one or more of the following:
measurement type,
one or more identifiers associated with reference signals (RS) to be measured,
measurement duration,
need for measurement uncertainty,
need for UE location, and
need for periodic measurement reporting.

B7a. The method of embodiment B7, wherein the one or more identifiers associated with RS to be measured include one or more of the following: index of a synchronization signal/PBCH (SSB) to be measured, identifier of a transmission/reception point (TRP) that transmits a RS to be measured, identifier of a positioning reference signal (PRS) resource set to be measured, and identifier of a PRS resource to be measured.

B8. The method of any of embodiments B5-B7, wherein the information received from each of the one or more UEs is based on one or more of the following: the UE determining that the measurement reporting conditions are met, and the configuration of requested measurements.

B9. The method of any of embodiments B1-B8, wherein one of the following applies:
the second indication and the one or more measurements are received in a single message; or
the second indication is received in a first message and the one or more measurements are received in a subsequent second message.

B10. The method of any of embodiments B1-B9, wherein one of the following applies:
the UE is a positioning reference unit (PRU) and the NNF is a location management function (LMF) in a 5G core network (5GC); and
the UE is a sensing UE and the NNF is a sensing management function (SeMF) in a 5GC.

B11. The method of any of embodiments B1-B10, further comprising performing the positioning and/or sensing operations relating to the target based on the one or more measurements received from each of the one or more UEs.

B12. The method of any of embodiments B1-B11, wherein transmitting the indication to the RAN is based on determining that no stationary assisting UEs are available in an area proximate to the target.

C1. A method for a radio access network (RAN) node configured to facilitate positioning and/or sensing operations in a communication network, the method comprising:
receiving, from a network node or function (NNF) configured to manage positioning and/or sensing operations in the communication network, an indication that assisting user equipment (UEs) are needed for positioning or sensing operations relating to a target; and
transmitting, in one or more cells served by the RAN node, a corresponding indication that assisting UEs are needed by the NNF for positioning and/or sensing operations relating to a target.

C2. The method of embodiment C1, wherein the indication is received as a request to broadcast the indication in one or more cells served by the RAN, and the corresponding indication is transmitted in a system information block (SIB) broadcast by the RAN node in the one or more cells.

C3. The method of any of embodiments C1-C2, wherein one of the following applies:
the indication is received from the NNF using a point-to-point protocol between the NNF and the RAN node; or
the indication is received via a core network node coupled to the RAN.

C4. The method of embodiment C1, wherein the indication is received in a request for the RAN node to transmit a reference signal (RS) associated with the requested positioning or sensing operations, and the corresponding indication is transmitted as the RS associated with the requested positioning or sensing operations.

C5. The method of any of embodiments C1-C4, wherein the indication is received, and the corresponding indication transmitted, together with one or more of the following
an address or identifier associated with the measurement collection node;
one or more measurement reporting conditions for assisting UEs; and
a configuration of requested measurements.

C6. The method of embodiment C5, wherein the measurement reporting conditions include one or more of the following: area of interest, minimum downlink (DL) signal strength, minimum DL signal quality, and line-of-sight (LOS) from assisting UE to RAN node.

C7. The method of any of embodiments C5-C6, wherein the configuration of requested measurements includes one or more of the following:
measurement type,
one or more identifiers associated with reference signals (RS) to be measured,
measurement duration,
need for measurement uncertainty,
need for UE location, and
need for periodic measurement reporting.

C7a. The method of embodiment C7, wherein the one or more identifiers associated with RS to be measured include one or more of the following: index of a synchronization signal/PBCH (SSB) to be measured, identifier of a transmission/reception point (TRP) that transmits a positioning reference signal (PRS) to be measured, identifier of a PRS resource set to be measured, and identifier of a PRS resource to be measured.

C8. The method of any of embodiments C1-C7a, wherein:
the RAN node comprises a centralized unit (CU) and one or more distributed units (DUs);
receiving the indication is performed by the CU;
transmitting the corresponding indication in the one or more cells is performed by the one or more DUs; and
the method further comprises the CU forwarding the indication to the one or more DUs.

C9. The method of any of embodiments C1-C8, wherein one of the following applies:
the assisting UEs are positioning reference units (PRUs) and the NNF is a location management function (LMF) in a 5G core network (5GC); and
the assisting UEs are sensing UEs and the NNF is a sensing management function (SeMF) in a 5GC.

D1. A user equipment (UE) configured to assist with positioning and/or sensing operations in a communication network, the UE comprising:
communication interface circuitry configured to communicate with a radio access network (RAN) and with a network node or function (NNF) configured to manage positioning and/or sensing operations in the communication network; and
processing circuitry operatively coupled to the communication interface circuitry, whereby the processing circuitry and the communication interface circuitry are configured to perform operations corresponding to any of the methods of embodiments A1-A10.

D2. A user equipment (UE) configured to assist with positioning and/or sensing operations in a communication network, the UE being further configured to perform operations corresponding to any of the methods of embodiments A1-A10.

D3. A non-transitory, computer-readable medium storing computer-executable instructions that, when executed by processing circuitry of a user equipment (UE) configured to assist with positioning and/or sensing operations, configure the UE to perform operations corresponding to any of the methods of embodiments A1-A10.

D4. A computer program product comprising computer-executable instructions that, when executed by processing circuitry of a user equipment (UE) configured to assist with positioning and/or sensing operations, configure the UE to perform operations corresponding to any of the methods of embodiments A1-A10.

E1. A network node or function (NNF) configured to manage positioning and/or sensing operations in a communication network, the NNF comprising:
communication interface circuitry configured to communicate with a radio access network (RAN) and with user equipment (UEs) configured to assist with positioning and/or sensing operations, via the RAN; and
processing circuitry operatively coupled to the communication interface circuitry, whereby the processing circuitry and the communication interface circuitry are configured to perform operations corresponding to any of the methods of embodiments B1-B12.

E2. A network node or function (NNF) configured to manage positioning and/or sensing operations in a communication network, the NNF being further configured to perform operations corresponding to any of the methods of embodiments B1-B12.

E3. A non-transitory, computer-readable medium storing computer-executable instructions that, when executed by processing circuitry of a network node or function (NNF) configured to manage positioning and/or sensing operations in a communication network, configure the measurement collection node to perform operations corresponding to any of the methods of embodiments B1-B12.

E4. A computer program product comprising computer-executable instructions that, when executed by processing circuitry of a network node or function (NNF) configured to manage positioning and/or sensing operations in a communication network, configure the measurement collection node to perform operations corresponding to any of the methods of embodiments B1-B12.

F1. A radio access network (RAN) node configured to facilitate positioning and/or sensing operations in a communication network, the RAN node comprising:
communication interface circuitry configured to communicate with a network node or function (NNF) configured to manage positioning and/or sensing operations in a communication network and with user equipment (UEs) configured to assist with the positioning and/or sensing operations; and
processing circuitry operatively coupled to the communication interface circuitry, whereby the processing circuitry and the communication interface circuitry are configured to perform operations corresponding to any of the methods of embodiments C1-C9.

F2. A radio access network (RAN) node configured to facilitate positioning and/or sensing operations in a communication network, the RAN node being further configured to perform operations corresponding to any of the methods of embodiments C1-C9.

F3. A non-transitory, computer-readable medium storing computer-executable instructions that, when executed by processing circuitry of a radio access network (RAN) node configured to facilitate positioning and/or sensing operations in a communication network, configure the RAN node to perform operations corresponding to any of the methods of embodiments C1-C9.

F4. A computer program product comprising computer-executable instructions that, when executed by processing circuitry of a radio access network (RAN) node configured to facilitate positioning and/or sensing operations in a communication network, configure the RAN node to perform operations corresponding to any of the methods of embodiments C1-C9.

1.-52. (canceled)

53. A method for a user equipment (UE) configured to assist with positioning and/or sensing operations in a communication network, the method comprising:
receiving, from a radio access network (RAN) node, a first indication that assisting UEs are needed for positioning or sensing operations related to a target other than the UE;
in response to the first indication, sending one or more of the following information to a network function (NF) configured to manage positioning and/or sensing operations in the communication network:
a second indication that the UE is available to assist with the positioning or sensing operations related to the target,
the UE's location, and
one or more measurements related to the target.

54. The method of claim 53, wherein the first indication is received according to one of the following:
in a system information block (SIB) broadcast by the RAN node in a cell in which the UE is located; or
as a reference signal (RS) transmitted by the RAN node.

55. The method of claim 53, wherein the first indication is received while the UE is in a non-connected state with respect to the RAN node, and the method further comprises, in response to the indication, entering a connected state with respect to the RAN node, after which the information is sent to the NF.

56. The method of claim 53, wherein the first indication is received together with one or more of the following:
an address or identifier associated with the NF;
one or more measurement reporting conditions for assisting UEs; and
configuration of requested measurements.

57. The method of claim 56, wherein the measurement reporting conditions include one or more of the following: area of interest, minimum downlink (DL) signal strength, minimum DL signal quality, and line-of-sight (LOS) from assisting UE to RAN node.

58. The method of claim 56, wherein the configuration of requested measurements includes or indicates one or more of the following: measurement type, one or more identifiers associated with reference signals (RS) to be measured, measurement duration, need for measurement uncertainty, need for UE location, and need for periodic measurement reporting.

59. The method of claim 58, wherein the one or more identifiers associated with RS to be measured include one or more of the following: index of a synchronization signal/PBCH (SSB) to be measured, identifier of a transmission/reception point (TRP) that transmits a RS to be measured, identifier of a positioning reference signal (PRS) resource set to be measured, and identifier of a PRS resource to be measured.

60. A method for a radio access network (RAN) node configured to facilitate positioning and/or sensing operations in a communication network, the method comprising:
receiving, from a network function (NF) configured to manage positioning and/or sensing operations in the communication network, a first indication that assisting user equipment (UEs) are needed for positioning or sensing operations related to a target; and
transmitting, in one or more cells served by the RAN node, a further first indication that assisting UEs are needed by the NF for positioning or sensing operations related to the target.

61. The method of claim 60, wherein the first indication is received as a request to broadcast the indication in one or more cells served by the RAN node, and the further first indication is transmitted in a system information block, SIB, broadcast by the RAN node in the one or more cells.

62. The method of claim 60, wherein one of the following applies:
the first indication is received from the NF using a point-to-point protocol between the NF and the RAN node; or
the first indication is received via a core network node coupled to the RAN node.

63. The method of claim 60, wherein the first indication is received in a request for the RAN node to transmit a reference signal, RS, associated with the positioning or sensing operations related to the target, and the further first indication is transmitted as the RS associated with the positioning or sensing operations.

64. The method of claim 60, wherein the first indication is received, and the further first indication is transmitted, together with one or more of the following
an address or identifier associated with the NF;
one or more measurement reporting conditions for assisting UEs; and
a configuration of requested measurements.

65. The method of claim 64, wherein the measurement reporting conditions include one or more of the following: area of interest, minimum downlink (DL) signal strength, minimum DL signal quality, and line-of-sight (LOS) from assisting UE to RAN node.

66. The method of claim 64, wherein the configuration of requested measurements includes one or more of the following: measurement type, one or more identifiers associated with reference signals (RS) to be measured, measurement duration, need for measurement uncertainty, need for UE location, and need for periodic measurement reporting.

67. The method of claim 66, wherein the one or more identifiers associated with RS to be measured include one or more of the following: index of a synchronization signal/PBCH (SSB) to be measured, identifier of a transmission/reception point (TRP) that transmits a RS to be measured, identifier of a positioning reference signal (PRS) resource set to be measured, and identifier of a PRS resource to be measured.

68. User equipment (UE) configured to assist with positioning and/or sensing operations in a communication network, the UE comprising:
communication interface circuitry configured to communicate with a radio access network (RAN) node and with a network function (NF) configured to manage the positioning and/or sensing operations; and
processing circuitry operatively coupled to the communication interface circuitry, wherein the processing circuitry and the communication interface circuitry are configured to:
receive, from the RAN node, a first indication that assisting UEs are needed for positioning or sensing operations related to a target other than the UE;
in response to the first indication, send one or more of the following information to the NF:
a second indication that the UE is available to assist with the positioning or sensing operations related to the target,
the UE's location, and
one or more measurements related to the target.

69. UE of claim 68, wherein the first indication is received according to one of the following:
in a system information block (SIB) broadcast by the RAN node in a cell in which the UE is located; or
as a reference signal (RS) transmitted by the RAN node.

70. The UE of claim 68, wherein the first indication is received together with one or more of the following: an address or identifier associated with the NF, one or more measurement reporting conditions for assisting UEs, and configuration of requested measurements.

71. Radio access network (RAN) node configured to facilitate positioning and/or sensing operations in a communication network, the RAN node comprising:
communication interface circuitry arranged to communicate with a network function (NF) configured to manage the positioning and/or sensing operations and with user equipment (UEs) configured to assist with the positioning and/or sensing operations; and
processing circuitry operatively coupled to the communication interface circuitry, wherein the processing circuitry and the communication interface circuitry are configured to:
receive, from the NF, a first indication that assisting UEs are needed for positioning or sensing operations related to a target; and
transmit, in one or more cells served by the RAN node, a further first indication that assisting UEs are needed by the NF for positioning or sensing operations related to the target.

72. The RAN node of claim 71, wherein the first indication is received, and the further first indication is transmitted, together with one or more of the following
an address or identifier associated with the NF;
one or more measurement reporting conditions for assisting UEs; and
a configuration of requested measurements.
